(19) United States
(12) Patent Application Publication
(10) Pub. No.: US 2009/0062432 A1
(43) Pub. Date: Mar. 5, 2009

(54) NOVEL POLYURETHANE COMPOSITIONS INCLUDING CASTOR OIL

(76) Inventors: VAN I. DOESBURG, Dalton, GA (US); Jeffrey Wayne Manning, Ooltewah, TN (US); Dennis L. Riddle, LaGrange, GA (US); Julie Ann Smallfield, Woodruff, SC (US); N. David Sellman, JR., LaGrange, GA (US); Richard L. Kilpatrick, LaGrange, GA (US)

Correspondence Address: KING & SPALDING LLP, 1180 PEACHTREE STREET, ATLANTA, GA, 30309-3521, US

(21) Appl. No.: 12/135,760

(22) Filed: Jun. 9, 2008

Related U.S. Application Data
(60) Provisional application No. 60/943,131, filed on Jun. 11, 2007.
(60) Provisional application No. 60/979,163, filed on Oct. 11, 2007.

(51) Int. Cl. C08L 75/04; C08G 71/04; C08K 3/26; C08L 97/02; C08K 3/36; B32B 27/40

(52) U.S. Cl. 524/16; 528/75; 428/220; 524/590; 524/425; 524/442; 524/444

(57) ABSTRACT

At least certain embodiments of the present invention relate to polyurethane compositions for forming a layer of polyurethane on a textile, fabric or material, such as a flooring fabric or a non-flooring fabric. The compositions comprise the reaction product of castor oil having a water content of less than or equal to about 0.2% by weight; a monol, and an isocyanate, wherein the reactants have a soft segment functionality of about 2.0 to about 2.64. Methods of using the compositions and products including the compositions are also disclosed. At least selected embodiments may provide compositions for use in surface coverings such as floor coverings having a show surface such as a textile or fabric face material in contacting overlying relation to a polyurethane backing with or without additional structures, layers, backings, and/or the like, as well as apparatus, processes, and/or methods for making such surface coverings, uses for such surface coverings, and/or the like. In at least one particular embodiment, a floor covering such as a carpet, carpet tile, area rug, floor mat, roll goods, or the like incorporates a textile or fabric face disposed in contacting overlying relation to at least one polyurethane layer.

### CROSS-REFERENCE TO RELATED APPLICATIONS

This application claims the benefit of application Ser. Nos. 60/943,131 filed Jun. 11, 2007, and 60/979,163 filed Oct. 11, 2007.

### FIELD OF THE INVENTION

In accordance with at least selected embodiments, the present invention relates generally to polyurethane coating compositions for textiles, fabrics, and the like including without limitation, polyurethane coating compositions for flooring products such as carpet, broadloom carpet, stabilized broadloom, carpet tile, modular carpet, roll goods, six foot goods, two meter goods, rugs, area rugs, runners, mats, floor mats, and the like, and coating compositions for non-flooring products, such as clothing, upholstery, contract fabrics, water barriers, tents, and the like. More specifically, in accordance with at least certain embodiments, the present invention relates to polyurethane compositions or formulations that provide desirable physical properties to textiles, fabrics, and the like including without limitation, flooring products such as carpet, broadloom carpet, stabilized broadloom, carpet tile, modular carpet, roll goods, six foot goods, two meter goods, rugs, area rugs, runners, mats, floor mats, or the like.

In accordance with at least selected polyurethane coating composition embodiments, processes, methods, uses, apparatus, and/or products are provided, for example, surface coverings such as floor coverings having a show surface such as a textile or fabric face material in contacting overlying relation to a polymer or resin backing, such as a polyurethane backing, with or without additional structures, layers, backings, and/or the like, as well as to apparatus, processes, and/or methods for making such surface coverings, uses for such surface coverings, and/or the like. In at least certain particular polyurethane coating composition embodiments, a floor covering such as carpet, broadloom carpet, stabilized broadloom, carpet tile, modular carpet, roll goods, six foot goods, two meter goods, rugs, area rugs, runners, mats, floor mats, or the like incorporate a textile or fabric face, such as a tufted, bonded, flocked, needled, needle punched, woven, non-woven, and/or knit textile or fabric structure disposed in contacting overlying relation to at least one polyurethane layer. The polyurethane layer or layers may form a precoat, tiecoat, backing, secondary backing, cap coat, binder, cushion and/or adhesive and may be, for example, foam or non-foam, filled or unfilled, of the same or of different compositions, and may preferably be flexible. One or more optional intermediate structure layers may be disposed on, over, in, or under the polyurethane layer or layers, and one or more optional backing layers or materials may be disposed across the underside of the polyurethane. In at least one more particular embodiment or example, a floor covering such as a hardback carpet, broadloom carpet, stabilized broadloom, carpet tile, modular carpet, roll goods, six foot goods, two meter goods, rugs, area rugs, runners, mats, floor mats, or the like incorporates a textile or fabric face, such as a tufted, bonded, flocked, needled, needle punched, woven, non-woven, knit, and/or the like textile or fabric structure (for example, tufted greige goods) disposed in overlying, contacting, bonding relation to a flexible and/or resilient, hardback polyurethane precoat, tiecoat, backing, secondary backing, cap coat, binder, cushion and/or adhesive. With a tufted greige goods face material (unbacked carpet face), the polyurethane backing or composition may form a combined precoat and backing, a combined precoat and tiecoat, combined precoat and binder, or a combined precoat, tiecoat and backing (precoat/backing, precoat/tiecoat, precoat/binder, or precoat/tiecoat/backing). Although it may not be preferred, one or more optional intermediate structure layers may be disposed on, over, in, or under the polyurethane layer or layers and one or more optional backing layers may be disposed across the underside of the polyurethane layer or layers.

### BACKGROUND OF THE INVENTION

Broadloom carpet is well known and has been used for commercial and residential applications for many years. Within the last decade or two, carpet tile or modular carpet has begun to be appreciated as a viable replacement for broadloom carpet, particularly in commercial applications. However, carpet tile has yet to make significant inroads into the replacement of broadloom carpet for residential applications.

One of the reasons that carpet tile has not been completely successful in replacing broadloom carpet may be the difficulties encountered in getting a carpet tile to lay flat on the floor. Traditional approaches have been directed to making the carpet tile stiff or rigid. Other approaches have been directed to either reducing stresses built into the tile during manufacturing or controlling the stresses built into the tile during manufacturing.

U.S. Pat. Nos. 4,296,159; 4,132,817; 4,405,393; 4,915,999; 4,522,857; 5,540,968; 5,545,276; 5,948,500; 6,203,881; and 6,468,623 (the disclosures of which are all incorporated herein by reference) and PCT Publication No. WO 2007/047844 show some of the different approaches taken in an effort to make an improved carpet or carpet tile product.

There has also been an effort in the carpet industry to include recycled materials and/or materials from renewable resources in their carpet products. U.S. Pat. Nos. 6,979,477; 6,962,636; 7,084,230; 7,063,877; 6,881,763; 6,867,239; 6,864,296; 6,465,569; 6,180,686; 6,624,244 (the disclosures of which are all incorporated herein by reference) and PCT Publication No. WO 98/08893 show some of the different approaches taken in an effort to include recycled materials or materials from renewable resources in carpet products. Of particular note are U.S. Pat. No. 4,035,529 (the disclosure of which is incorporated herein by reference) and UK Patent No. 1,573,778, both of which may disclose the use of castor oil in polyurethane compositions used for backing carpet products.

Surprisingly, it has been found that improved textile or fabric products, including without limitation, flooring products, such as carpet, broadloom carpet, stabilized broadloom, carpet tiles, modular carpet, roll goods, six foot goods, two meter goods, rugs, area rugs, runners, mats, floor mats, and the like, and non-flooring products, such as clothing, upholstery, contract fabrics, water barriers, tents, and the like, can be made by providing those products with one or more polyurethane coating compositions in accordance with at least certain disclosed embodiments of the present invention that may desirably have one or more of the physical properties of being relatively flexible/limp/drapeable, low shape memory, good tensile strength and hardness. Not only may such products have desirable physical properties, but the polyurethane coating compositions in accordance with at least certain embodiments of the present invention may also include recycled materials and/or materials from renewable resources.

### SUMMARY OF THE INVENTION

In at least selected embodiments, the present invention relates to compositions useful for coating substrates, such as textiles, fabrics, and the like. Such textile or fabric products may be, for example, surface coverings like floor coverings, wall coverings, furniture coverings, or the like. For flooring products such as carpet, broadloom carpet, stabilized broadloom, carpet tiles, modular carpet, roll goods, six foot goods, two meter goods, rugs, area rugs, runners, mats, floor mats, and/or the like, the composition may be used, for example, as a pre-coat, a tie-coat, a backing, a secondary backing, a cap coat, a binder, cushion, a layer, an adhesive and/or the like. In at least one embodiment, the composition comprises the reaction product of castor oil; a monol; and an isocyanate, wherein the reactants have a soft segment functionality of about 2.0 to about 2.64. Preferably, the reactants also may have a system functionality of about 2.0 to about 2.38. In certain embodiments, it may be desirable that the composition also has one or more of the following properties: a film drape of greater than or equal to 2 inches; a Shore A hardness of greater than or equal to 50; and, a tensile strength of greater than or equal to 100 psi.

In another embodiment, the invention comprises a method of making a composition. The method comprises: reacting together castor oil; a monol; an isocyanate; and, a catalyst to form a polyurethane composition, wherein the reactants have a soft segment functionality of about 2.0 to about 2.64. Preferably, the reactants also have a system functionality of about 2.0 to about 2.38. The polyurethane composition is then permitted to cure, cured, or the like.

In yet another embodiment, the invention comprises a composition useful for coating textile fabrics, such as carpet backing and carpet tile backing. In one embodiment the composition comprises: (a) the reaction product of: (i) about 15 to about 98 parts by weight castor oil; (ii) about 1 to about 30 parts by weight of a monol; (iii) 0 to about 84 parts by weight of a polyol; and, (iii) about 7 to about 60 parts by weight of an isocyanate, wherein the reactants have a soft segment functionality of about 2.0 to about 2.64; and (b) 0 to about 500 parts by weight of a filler.

Accordingly, it is an object of at least one embodiment of the present invention to provide an improved polyurethane composition.

Another object of at least one embodiment of the present invention is to provide an improved polyurethane coating composition for a polyurethane coated textile, fabric, flooring product, non-flooring product, or the like.

A further object of at least one embodiment of the present invention is to provide an improved method for making a polyurethane composition.

Yet another object of at least one embodiment of the present invention is to provide an improved method for making polyurethane coated textiles, fabrics, broadloom carpet, carpet tile, modular carpet, or the like.

A further object of at least one embodiment of the present invention is to provide a polyurethane coating composition for a carpet tile that may lay flatter on the floor than prior carpet tile.

Another object of at least one embodiment of the present invention is to provide a coating for a textile, fabric, or the like, for use in flooring products and non-flooring products and that may have one or more of the physical properties of being relatively flexible/limp/drapeable, low shape memory, good tensile strength and hardness.

At least selected embodiments of the present invention may provide advantages over and/or alternatives to the prior constructions by providing processes, methods, uses, apparatus, compositions, and/or products, for example, polyurethane coating compositions for surface coverings such as floor coverings having a show surface such as a textile or fabric face material in contacting overlying relation to a polymer or resin backing or composition, such as a polyurethane composition or backing with or without additional structures, layers, backings, and/or the like, as well as apparatus, processes, and/or methods for making such surface coverings, uses for such surface coverings, and/or the like. In at least one particular embodiment, a polyurethane coating composition for a floor covering or flooring product or flooring such as carpet, broadloom carpet, stabilized broadloom, carpet tile, modular carpet, roll good, six foot good, two meter good, rug, area rug, runner, mat, floor mat, artificial turf, pad, padding, underlayment, or the like incorporates a textile or fabric face, such as a tufted, bonded, flocked, needled, needle punched, woven, non-woven, and/or knit textile or fabric structure disposed in contacting overlying relation to at least one polyurethane layer. The polyurethane layer or layers may form a precoat, tiecoat, backing, secondary backing, cap coat, binder, cushion and/or adhesive and may be foam or non-foam, filled or unfilled, of the same or different compositions or formulations, and may preferably be resilient and/or flexible. One or more optional intermediate structure layers may be disposed over, on, in, or under the polyurethane layer or layers and one or more optional backing layers may be disposed across the underside of the polyurethane layer or layers. In at least one more particular polyurethane coating composition embodiment or example, a floor covering such as a hardback carpet, carpet tile, area rug, roll good, or the like incorporates a textile or fabric face, such as a tufted, bonded, flocked, needled, needle punched, calendered, woven, non-woven, or knit textile or fabric structure (for example, tufted greige goods) disposed in overlying, contacting, bonding relation to a flexible and/or resilient, hardback polyurethane backing. With a tufted greige goods face material (unbacked carpet face), the polyurethane backing or layer may form a combined precoat and backing (precoat/backing), a combined precoat and tiecoat (precoat/tiecoat), a combined precoat and binder (precoat/binder), or a combined precoat, tiecoat and backing (precoat/tiecoat/backing). Although it may not be preferred, one or more optional intermediate structure layers may be disposed on, over, in, and/or under the polyurethane backing, layer or layers and one or more optional backing layers may be disposed across the underside of the polyurethane backing, layer or layers.

In accordance with at least selected embodiments, the present invention relates to processes, methods, uses, apparatus, and/or products, for example, polyurethane coating compositions for surface coverings such as floor coverings, for example, carpet, carpet tiles, area rugs, floor mats, flooring, floor tiles, rugs, mats, runners, broadloom carpet, stabilized broadloom, roll goods, modular flooring, 6-foot broadloom, or the like incorporating a textile or fabric face, such as a tufted, bonded, flocked, needled, needle punched, calendered, woven, non-woven, and/or knit textile or fabric structure disposed in contacting overlying relation to at least one polymer or resin layer, such as a polyurethane composition, layer or backing. One or more optional intermediate structure layers may be disposed on, over, in, and/or under the polyurethane layer or layers, and one or more optional backing layers or components may be disposed across the underside of the polyurethane layer or layers.

According to a potentially preferred particular embodiment or example, the polyurethane is in direct contacting relation with the underside of the textile, fabric, or textile fabric face structure without the need for any intermediate binder or precoat.

According to another potentially preferred particular polyurethane coating composition embodiment or example, the textile or fabric face structure is preferably substantially relaxed such as by steaming, dyeing, drying, heating, and/or the like prior to application of the polyurethane to substantially avoid subsequent deformation, for example, due to shrinkage.

According to still another potentially preferred particular polyurethane coating composition embodiment or example, a common formation unit and process may be used to produce carpet, area rugs, carpet tile, floor mats, runners, roll goods, and the like.

According to yet another potentially preferred particular polyurethane coating composition embodiment or example, resilient and/or flexible, polyurethane hardback carpet tiles having, for example, a tufted or bonded carpet surface or face are provided. Such carpet tiles may preferably be employed in residential, educational, institutional, health care, hospitality, and/or commercial installations or markets.

These and other objects, advantages, features, aspects, embodiments, and/or examples and further scope of the applicability of the present invention may be or will become apparent after a review of or from the detailed description to follow or the disclosed embodiments, taken in conjunction with the appended claims and accompanying drawings wherein like parts are designated by like reference numerals in the various views.

### BRIEF DESCRIPTION OF THE DRAWINGS

Certain embodiments or disclosures will now be further described by way of example and with reference to the drawings, which are briefly described as follows:

FIG. 1 is a schematic diagram of at least one embodiment of an apparatus and process for forming one or more layers of a polyurethane composition on a textile, fabric, or material, such as a flooring fabric or a non-flooring fabric in accordance with at least certain disclosed embodiments;

FIG. 2 is a partial enlarged or detailed view of a portion of belt 12 and optional layer 47 of FIG. 1;

FIG. 3 is a cross-sectional view illustrating an exemplary polyurethane-backed surface covering incorporating a tufted face structure in accordance with at least selected embodiments;

FIG. 4 is a cross-sectional view illustrating another exemplary polyurethane-backed surface covering incorporating a tufted face structure in accordance with at least selected embodiments;

FIG. 5 is a cross-sectional view illustrating an exemplary polyurethane-coated fabric in accordance with at least other selected embodiments wherein the fabric is for non-flooring applications;

FIG. 6 is schematic side view illustrating another exemplary apparatus and process for forming various polyurethane-backed surface coverings as well as others;

FIG. 7 is a cross-sectional view illustrating another exemplary polyurethane-backed surface covering incorporating a tufted face structure;

FIG. 8 is a cross-sectional view illustrating an exemplary polyurethane-backed surface covering incorporating a woven face structure;

FIG. 9 is a cross-sectional view illustrating an exemplary polyurethane-backed surface covering incorporating a non-woven face structure;

FIG. 10 is a cross-sectional view illustrating an exemplary polyurethane-backed surface covering incorporating a bonded pile face structure;

FIG. 11 is a cross-sectional view illustrating an exemplary surface covering like that of FIG. 7 with the addition of a backing such as a coating, film, backing and/or the like;

FIG. 12 is a cross-sectional view illustrating an exemplary surface covering like that of FIG. 8 except that it is inverted as constructed using an exemplary apparatus and process as shown in FIG. 14;

FIG. 13 is a cross-sectional view illustrating an exemplary surface covering like that of FIG. 12 except that it includes an additional backing;

FIG. 14 is a schematic side view illustration of an exemplary apparatus and process for forming polyurethane backed surface coverings as well as others in accordance with another embodiment;

FIG. 15 is a cross-sectional view illustrating another exemplary polyurethane-backed surface covering incorporating a tufted face structure and an additional backing layer; and

FIG. 16 is a cross-sectional view illustrating yet another exemplary polyurethane-backed surface covering incorporating a tufted face structure and an additional backing layer.

### DETAILED DESCRIPTION OF THE DISCLOSED EMBODIMENTS

At least one disclosed embodiment of the present invention is a polyurethane composition. The disclosed polyurethane composition is used for coating textiles, fabrics, or the like, is used in flooring and in non-flooring products, and is used for coating textiles, fabrics or materials such as tufted, flocked, needled, needle punched, woven, nonwoven, knitted, and/or the like. The polyurethane composition may be particularly useful for coating the backing of carpet (possibly preferably greige goods). The disclosed polyurethane composition is especially useful for coating the back or bottom surface of the face fabric of carpet tile. However, the disclosed polyurethane composition can also be used to coat the back or bottom of broadloom carpet. The disclosed polyurethane composition can also be used as an adhesive or tiecoat to adhere one or more layers together, such as one layer of textile, substrate, or fabric to another layer of textile, substrate, fabric, or other material or layer.

In another disclosed embodiment of the present invention, the polyurethane composition may be used as a pre-coat, tie-coat, backing, secondary backing, cap coat, adhesive, cushion, layer and/or the like in flooring products, such as carpet tile, modular carpet, roll goods, broadloom carpet, attached cushion broadloom carpet, stabilized broadloom carpet, rugs, area rugs, runners, mats, floor mats, and the like, or in non-flooring products, such as clothing, upholstery, contract fabrics, water barriers, tents, and the like.

Prior attempts to make carpet tile lay flat include making the tile as rigid or stiff as possible. Layers of reinforcement were typically added and stiff coatings of elastomers have been used. For example, prior polyurethane coatings sought stiff coatings by including in the polyurethane reactants cross-linkers, chain extenders and/or reactants with increased functionality; i.e., increased functionality of the B-side components, such as the polyols, and increased functionality of the A-side components, such as the isocyanates. Thus, prior polyurethane compositions for use with carpet and especially carpet tile have sought to maximize soft segment functionality and system functionality.

At least certain disclosed embodiments of the present invention depart from the direction of the prior backings with respect to carpet, and especially with respect to carpet tile. Instead of striving for a rigid tile, certain disclosed embodiments of the present invention seek a flexible carpet tile with a polyurethane coating or coatings that has one or more of the physical properties of being relatively flexible/limp/drapeable, low shape memory, good tensile strength and hardness, and, preferably, all of these characteristics.

In order to accomplish this, a polyurethane composition that can be applied to the back of a carpet or carpet tile face or fabric as a pre-coat, a tie-coat, a backing, a secondary backing, a cap coat, a cushion, layer and/or an adhesive has been developed as illustrated by at least certain of the present disclosed embodiments. Polyurethane is typically the reaction product of a hydrocarbon having reactive hydroxyl functional units (B side) and an isocyanate (A side). In the polyurethane compositions of at least selected of the disclosed embodiments, hydrocarbons having reactive hydroxyl functional units comprise two or more separate components: castor oil, a monol, and optionally a polyol. The ratio of the castor oil, the monol and the optional polyol are such that the combination preferably has a soft segment functionality of about 2.0 to about 2.64; more preferably, about 2.07 to about 2.64; especially, preferably about 2.1 to about 2.4. Furthermore, in the polymerization reaction, the monol acts as a chain terminator, thereby limiting the crosslink density of the polyurethane. By controlling and/or adjusting these ingredients, it is preferred that the polyurethane have a crosslink density of about 2.07 to about 2.38.

Castor oil is a vegetable oil obtained from the castor bean (technically castor seed as the castor plant, Ricinus communis, is not a member of the bean family). Castor oil has an unusual composition and chemistry, which makes it quite valuable. Ninety percent of fatty acids in castor oil are ricinoleic acid. Ricinoleic acid is a monounsaturated, 18-carbon fatty acid, which has a hydroxyl functional group at the twelfth carbon, a very uncommon property for a biological fatty acid. This functional group causes ricinoleic acid (and castor oil) to be unusually polar, and also allows chemical derivitization that is not practical with other biological oils. Since it is a polar dielectric with a relatively high dielectric constant (4.7), highly refined and dried castor oil is sometimes used as a dielectric fluid within high performance high voltage capacitors. The amount of castor oil that can be used in at least selected disclosed embodiments of the present invention is that amount that can be used and still achieve the desired soft segment functionality as defined herein, but in these at least selected disclosed embodiments less than 100% castor oil as the total hydroxyl-containing component. Since castor oil is a relatively inexpensive natural oil polyol product that is obtained from a renewable resource, it may be desirable to include as much castor oil in the formulation or composition as possible. Generally speaking, it is desirable to use about 45 to about 98 parts by weight castor oil per 100 parts by weight of total hydroxyl-containing components in the disclosed embodiment of the invention; preferably, about 45 to about 75 parts by weight per 100 parts by weight of total hydroxyl-containing components.

Castor oil, also known as ricinus oil, is a triglyceride of fatty acids. Since castor oil is a natural product, it is not a pure product. A typical castor oil will include about 89.5% ricinoleic acid (12-hydroxyoleic acid), 4.2% linoleic acid, 3.0% oleic acid, 1.0% stearic acid, 1.0% palmitic acid, 0.7% dihydroxystearic acid, 0.3% linolenic acid, and 0.3% elcosanoic acid. Furthermore, castor oil usually contains as much as 0.5% by weight water. Castor oil has a true functionality of about 2.64 and an equivalent weight of about 342. Since water is not usually desirable in a polyurethane reaction designed to produce an elastomer or non-blown, non-cellular, non-foam product, it is preferred to use dry castor oil in the elastomer or non-blown, non-cellular, non-foam disclosed embodiments of the invention. Therefore, the castor oil preferably has less than about 0.2% by weight water in it; especially, preferably less than about 0.1% by weight water. A dry castor oil useful in the present invention can be obtained from Vertellus Specialties, Inc. under the designation Dry #1 Imported Oil. Unmodified castor oil (i.e., filtered and dried) may be preferred. Other natural oil polyols may require chemical treatment to be used as a polyol. Castor oil comes in several grades. Possibly preferred castor oils are industrial dry castor oil, food grade dry castor oil, polyurethane grade castor oil, and premium polyurethane grade dry castor oil. The castor oil may be a blend, combination, or mixture of castor oils, grades of castor oil, or the like.

Monols used in at least selected disclosed polyurethane formulations or compositions are preferably a hydrocarbon having a single hydroxyl functional group. Any monol or monol combination, blend or mixture that can be polymerized with isocyanate to form polyurethane can be used in the polyurethane compositions or formulations of the present invention. As used herein the term “monol” means a molecule, polymer or co-polymer having a single reactive hydroxyl group per molecule or polymer or co-polymer chain. Since the monol preferably has a single reactive hydroxyl group, the monol has a true functionality of about 1. Thus, when the monol is combined with the castor oil and/or with higher functionality polyols, the monol tends to lower the soft segment functionality of the disclosed embodiments.

Monols useful in certain disclosed embodiments of the present invention include, but are not limited to, glycol ethers, higher alcohols (i.e., C4 to C18 alcohols, either linear or branched) and ester alcohols. Preferred monols have a chain length of about 4 to about 100 carbons. Preferred monols include, but are not limited to, glycol ethers, such as diethylene glycol monomethyl ether, diethylene glycol monoethyl ether, diethylene glycol monopropyl ether, diethylene glycol monobutyl ether, diethylene glycol monohexyl ether, diethylene glycol mono-2-ethylhexyl ether, dipropylene glycol monomethyl ether, dipropylene glycol monoethyl ether, dipropylene glycol monopropyl ether, dipropylene glycol monobutyl ether, dipropylene glycol monohexyl ether, dipropylene glycol mono-2-ethylhexyl ether, triethylene glycol monomethyl ether, triethylene glycol monoethyl ether, triethylene glycol monopropyl ether, triethylene glycol monobutyl ether, triethylene glycol monohexyl ether, triethylene glycol mono-2-ethylhexyl ether; higher alcohols, such as 2-ethyl hexanol and 1-decanol; and ester alcohols, such as 2,2,4-trimethyl-1,3-pentanediol monoisobutyrate, and mixtures thereof.

The monol is used to modify the functionality of the hydroxyl-containing components of the polyurethane reaction; i.e., the “B-side”, to increase flexibility, as a chain terminator, or the like. For example, for at least certain textile, fabric, broadloom carpet, and/or carpet tile applications, the soft segment functionality, or B-side functionality, is preferably about 2.0 to about 2.64; more preferably, about 2.07 to about 2.64; especially, preferably about 2.1 to about 2.4. System functionality is based on the functionality of both the A-side and the B-side. Therefore, in the possibly preferred disclosed embodiments, the soft segment functionality and the functionality of the isocyanate portion, or A-side functionality, are selected so that the system functionality is within a desired range. For example, in at least selected carpet tile applications, the system functionality is preferably about 2.0 to about 2.4; more preferably, about 2.07 to about 2.38; especially, preferably about 2.1 to about 2.25. For at least certain textile, fabric, and broadloom carpet applications, the system functionality is preferably about 2.0 to about 2.64. Generally speaking, it is desirable to use about 1 to about 30 dry parts by weight monol (or monol mixture) in at least selected disclosed embodiments of the invention; preferably, about 2 to about 20 parts by weight per 100 parts by weight of total hydroxyl-containing components.

The soft segment functionality is calculated as described below and as illustrated by the following example. The B-side comprises 93 parts by weight of castor oil which has an equivalent weight of 342 and a functionality of 2.68 and 7 parts by weight diethylene glycol monobutyl ether which has an equivalent weight of 162 and a functionality of 1.00. The functionality of the B-side, or soft segment functionality, is calculated by dividing the parts by weight of each ingredient by its respective equivalent weight to yield an equivalence number for each ingredient. The equivalence numbers are totaled. The equivalence number for each ingredient is then divided by the total equivalence number to yield a percent equivalence for each ingredient. The percent equivalence for each ingredient is then multiplied by the true functionality of each ingredient to yield a functional contribution of each ingredient. The functional contributions of each ingredient are then totaled to yield the total functionality of the soft segment. These calculations are illustrated in Table 1 below.

TABLE 1

| | Parts by | Equivalent | No. | % | True | Functional |
|---|---|---|---|---|---|---|
| Ingredient | Weight | Weight | Equivalence | Equivalence | Functionality | Contribution |
| DFNO | 93 | 342 | 0.271929825 | 0.862886598 | 2.68 | 2.312536082 |
| Dry castor | | | | | | |
| oil | | | | | | |
| GL Ether | 7 | 162 | 0.042309877 | 0.137113402 | 1.00 | 0.137113402 |
| DB | | | | | | |

| | | | |
|---|---|---|---|
| Total Equivalence No. | 0.315139701 | Average Functionality | 2.45 |

The system functionality is calculated in the same manner, except that the functionality of the isocyanate is considered, as well. Thus, adding 45.6 parts by weight of an isocyanate having a functionality of 2.05 and an equivalent weight of 143 to the foregoing formulation produces a system functionality of 2.25. This system functionality is calculated as shown in Table 2 below.

TABLE 2

| | Parts by | Equivalent | No. | % | True | Functional |
|---|---|---|---|---|---|---|
| Ingredient | Weight | Weight | Equivalence | Equivalence | Functionality | Contribution |
| DNFO | 93 | 342 | 0.271929825 | 0.4320842 | 2.68 | 1.1579856 |
| Dry castor | | | | | | |
| oil | | | | | | |
| GL Ether | 7 | 162 | 0.042309877 | 0.0672283 | 1.00 | 0.0672283 |
| DB | | | | | | |
| Isonate | 45.06 | 143 | 0.3151048 | 0.5006873 | 2.05 | 1.0264089 |
| 143L | | | | | | |

| | | | |
|---|---|---|---|
| Total Equivalence No. | 0.6293444 | Average Functionality | 2.25 |

The polyurethane compositions of the disclosed embodiments can optionally contain a relatively minor or small amount of one or more other polyols (not castor oil), such as those typically used to make polyurethane. Any polyol typically used to form polyurethane can be used in the formulation or composition and such polyols are well known to those skilled in the art. However, the functionality of the polyol and the amount of the polyol used in at least selected embodiments of the disclosed compositions or formulations of the present invention should be such that the soft segment functionality is within the desired ranges set forth above. Polyols useful in the disclosed embodiments of the present invention include, but are not limited to, polyethylene glycol, polypropylene glycol, polybutylene glycol, 1,2-poly-dimethylene glycol, polydecamethylene glycol, polyether polyols derived from propylene oxide, ethylene oxide and mixtures of such oxides; ethylene oxide capped co-polymers of ethylene oxide and propylene oxide; and mixtures thereof. Preferred polyols have an average molecular weight of about 2,000 to about 6,000, and particular preferred polyols have a molecular weight of about 3,000 to about 5,000. Generally speaking, it is desirable to use 0 to about 84 parts by weight other or optional polyol (not castor oil) in at least certain of the disclosed embodiments of the invention; preferably, about 5 to about 60 parts by weight other polyol; more preferably, about 10 to about 40 parts by weight other polyol per 100 parts by weight of total hydroxyl-containing components.

The isocyanate that is used in the polyurethane compositions or formulations is any isocyanate or isocyanate mixture that can be reacted with the hydroxyl-functional components to form polyurethane; i.e., the castor oil, the monol and the optional one or more other polyols. Particularly suitable isocyanates include but are not limited to aromatic diisocyanates as they are more reactive and less toxic than the aliphatic diisocyanates. Preferred isocyanates are methylene diphenyl 4,4′-diisocyanate (“MDI”) and a polymeric MDI (polymethylene polyphenylisocyanate that contains MDI). Other suitable isocyanates include, but are not limited to, 2,4-toluene diisocyanate, 2,6-toluene diisocyanate, methane diisocyanate, naphthylene 1,4-diisocyanate, diphenylmethyl-4,4′-diisocyanate, 3,3′-dimethoxy biphenylene diisocyanate, 4,4′-diphenylene diisocyanate, 1,6-hexamethylene diisocyanate; 3,3′-dimethoxy biphenylene diisocyanate, modified MDI, and mixtures thereof. The isocyanate usually is employed in stoichiometric excess to assure complete reaction with the functional groups of the castor oil, the monol and the optional one or more other polyols. Preferably from about 20 to about 80 parts by weight isocyanate per 100 parts by weight of hydroxyl-containing components; more preferably, about 40 to about 60 parts by weight isocyanate per 100 parts by weight of hydroxyl-containing components are used in the disclosed compositions or formulations of at least certain embodiments of the present invention.

Polyurethane catalysts are well known in the art and are useful in the disclosed compositions or formulations of the present invention. Suitable catalysts are those which promote polyurethane formation and include, but are not limited to, organic metal compounds, such as tin octoate, dimethyltin diacetate, diethyltin diacetate, dibutyltin diacetate, nickel acetylacetonate; amines, such as tertiary amines, for example, 1,4 diaza-bicyclo-octane (triethylenediamine), diethylenediamine and triethyldiamine (“TEDA”); metal soaps, such as dibutyl tin dilaurate, stannous octoate; and mixtures thereof. For certain applications, a heat sensitive, delayed action catalyst may be preferred, such as DABCO WT (a formic acid blocked TEDA) available from Air Products. Generally speaking, it is desirable to use about 0 to about 2 parts by weight catalyst per 100 parts by weight of hydroxyl-containing components in the disclosed compositions or formulations of the present invention; preferably, about 0.01 to about 2.0 parts by weight; more preferably, about 0.02 to about 0.5 parts by weight.

The polyurethane compositions of at least selected disclosed embodiments can contain any of the additives typically added to polyurethane compositions used, for example, in the textile or carpet industry, such as fillers, additives, agents, colorants, flame retardants, antimicrobial agents, wetting agents, surfactants, blowing agents, such as water or low boiling fluorocarbons, chain extenders, odor control agents, and/or the like. Chain extenders, such as diethylene glycol and dipropylene glycol, may be used.

One such typical additive is a filler, which is usually used to reduce costs. Filler is used in at least selected of the present disclosed embodiments to increase the specific gravity of the polyurethane composition, to reduce cost, to add recycled content, and/or the like. If the coating that is applied, for example, to the back or backing of the carpet tile face fabric or material is relatively heavy, it will help keep the carpet tile flat on the floor. Therefore, it may be desirable for the polyurethane composition to have a specific gravity of greater than 1.2; preferably, about 1.2 to about 5; especially, preferably about 1.5 to about 3.5. Preferred fillers for use in the polyurethane compositions of at least certain of the disclosed embodiments are coal fly ash, glass cullet, post-consumer glass cullet, alumina trihydrate, barium sulphate, foundry sand, used foundry sand, metal, recycled metal, dense fillers (fillers with a specific gravity (SG) greater than 2, preferably greater than 5, such as Iron (Fe) with a SG of about 7.8), ferromagnetic material (provides the option of selectively creating permanent magnetic properties in the backing using, for example, a magnetron located on or after the production range that can be switched on or off to produce the optional magnetic property), oxide ferromagnetic material (such as ferrite, is not only dense and magnetizable, but will also starve a fire event from oxygen and self extinguish), magnetite, iron oxides, ferrite, iron, steel, nickel, metals, recycled metals, barite, sand, glass, recycled glass, recycled soda lime glass, glass particles, glass fibers, gypsum, recycled gypsum, coal fly ash, calcium carbonate, magnesium carbonate, magnesium sulfate, aluminum hydrate, barium sulfate, aluminum silicate, diatomaceous earth, asbestos fibers, silica, titanium dioxide, barytes, carbon black, cork, recycled cork, clay, rubber, recycled rubber, waste flooring, recycled flooring, recycled carpet tile, other particles, chips, fibers, or the like, and/or blends and combinations thereof. Fillers are typically added in amounts by weight totaling from 0% to about 95%. Fillers are typically fine ground particles less than 50 mesh (297 microns) in size but may be larger, a mixture of sizes and/or shapes, or the like. However, any suitable filler or combination of fillers can be used. Generally speaking, it is desirable to use 0 to about 500 dry parts by weight filler per 100 parts by weight hydroxyl-containing components in the disclosed formulations of the present invention; preferably, about 100 to about 300 dry parts by weight filler per 100 parts by weight hydroxyl-containing components.

In order for the polyurethane composition to penetrate the textile or fabric back, backing, or bottom, such as the back stitch and primary backing (or tufting substrate) of tufted greige goods (carpet backing) sufficiently to achieve a satisfactory bond strength, and in the case of tufted carpet, sufficient bundle or tuft lock, the polyurethane should preferably not be too viscous. On the other hand, polyurethane compositions having too low a viscosity may penetrate the textile or fabric back or backing (such as carpet backing) too much, resulting in strike through, or they may be absorbed too much by the carpet or other adjacent layers, such as stabilizing or reinforcing layers, for example, a layer of fiberglass, backing layers, or the like (possibly resulting in undesirable strikethrough). Therefore, it may be preferred that the polyurethane compositions have a viscosity of about 1,000 to about 24,000 Centipoise at 75° F.; especially, preferably about 2,000 to about 10,000 Centipoise at 75° F. It may be especially preferred that the polyurethane composition be thixotropic.

To modify the viscosity of the polyurethane composition, it therefore may be desirable to include a viscosity modifier. A possibly preferred viscosity modifier for use in the polyurethane compositions is fumed silica and calcined or treated clay. Sufficient quantities of the viscosity modifier are used to achieve the viscosity of the composition as described above. Other suitable viscosity modifiers include, but are not limited to, polyols, wetting agents, surfactants, and the like. The amounts of the viscosity modifier useful in the present invention are preferably those amounts necessary to obtain the desired viscosity and generally include, but are not limited to, 0 to about 20 dry parts by weight viscosity modifier per 100 parts by weight hydroxyl-containing components.

Although it is contemplated that certain disclosed embodiments of the polyurethane composition may be used as an elastomer, it is also specifically contemplated that the polyurethane composition can also be used in a foam or cellular form. To make a foam or cellular product, the composition can be either chemically blown or mechanically frothed, using methods well known in the art. To produce a chemically blown composition, blowing agents, such as water or low boiling fluorocarbons, may be included in the polyurethane composition. To produce mechanically frothed foams or cellular products, one or more surfactants may be included in the polyurethane composition.

Table 3 below shows a typical B-side of the polyurethane composition in accordance with a disclosed embodiment of the present invention.

TABLE 3

| | | Preferred Range |
|---|---|---|
| Ingredient | Parts by Weight | (Parts by Weight) |
| DFNO Dry castor oil | 65 | 45-75 |
| Voranol 9240 | 25 | 5-60 |
| Glycol ether DB | 10 | 2-20 |
| PV20A coal fly ash | 260 | 100-300 |
| 3A Sieve | 3 | 0-5 |
| Cabosil TS-720 | 1 | 0-20 |
| Catalyst | 0.12 | 0.02-0.5 |
| TOTAL | 364.12 | |

In Table 3 above, dry castor oil is commercially available from Vertellus Specialties, Inc. under the designation Dry #1 Imported Oil castor oil (having a maximum of 0.1% by weight water); Voranol 9240 is a polyol available from the Dow Chemical Company; Glycol ether DB is diethyleneglycol monobutyl ether commercially available from Ashland Chemical; 3A Sieve is a molecular sieve available from UOP, LLC; PV20A is coal fly ash available from Boral Mineral Technologies; and, Cabosil TS-720 is fumed silica available from Cabot Corp.

Table 4 below shows a typical A-side of the polyurethane composition in accordance with a disclosed embodiment of the present invention.

TABLE 4

| | | Preferred Range |
|---|---|---|
| Ingredient | Parts by Weight | (Parts by Weight) |
| FI-C344 KD isocyanate | 50.4 | 10-60 |

FI-C344 KD isocyanate is a mixture of polymeric MDI and a pre-polymer of MDI available from Textile Rubber and Chemical Company, Inc.

As used herein, the term “film drape” is measured as described below. A polyurethane film is produced by molding a film 4 inches wide by 12 inches long and having a thickness of 0.070 to 0.080 inches from the polyurethane compositions of the disclosed embodiments. The film is placed on a flat, horizontal surface having a planar, vertical edge. The film is then moved longitudinally on the flat surface until 4 inches of the film overhangs the planar, vertical edge of the flat surface (4 inches of film overhang or cantilever). Then, while holding the remainder of the film flat against the flat surface, after a period of five minutes, the difference in vertical height between the flat surface and the overhanging end of the film is measured. The difference in vertical height is the film drape. This is a modification of the test described in ASTM 325-35. The film used to measure film drape is made only from the polyurethane polymer; i.e., the reaction product of the hydroxyl-containing components and isocyanate, and does not include other additives, such as filler or the like.

The following examples are illustrative of selected embodiments of the present invention and are not intended to limit the scope of the invention as set forth in the appended claims.

### EXAMPLE 1

A textile coating composition is prepared from the ingredients shown in Table 5 below.

TABLE 5

| Ingredient | Parts by weight |
|---|---|
| Dry Castor oil | 100 |
| Isonate 143L | 42.65 |
| Tin catalyst UL-29 | 0.05 |

Dry castor oil is commercially available from Vertellus Specialties, Inc. under the designation Dry #1 Imported Oil (having a maximum of 0.1% by weight water). Isonate 143L is a uretonimine modified MDI available from Dow Chemical Company. UL-29 tin catalyst is a dioctyltin mercaptide catalyst available from Witco Chemical Company.

This composition has a soft segment functionality of 2.68 and a system functionality of 2.36. When this composition is used to produce a textile coating composition, it produced a film having a film drape of 1.875 inches, a Shore A Durometer of 74, a tear strength of 116.73, a tensile strength of 752.91, an elongation of 140.47, and a density of 67.54. This composition is believed not preferably suitable for use in selected broadloom carpet or carpet tile applications in accordance with the present invention, because the film drape is not greater than or equal to about 2 inches and the soft segment functionality is greater than 2.64.

### EXAMPLE 2

A textile coating composition is prepared from the ingredients shown in Table 6 below.

TABLE 6

| Ingredient | Parts by weight |
|---|---|
| Dry Castor oil | 100 |
| PAPI 94 | 39.70 |
| Tin catalyst UL-29 | 0.05 |

Papi 94 is a polymeric MDI (polymethylene polyphenylisocyanate that contains MDI), available from the Dow Chemical Company.

This composition has a soft segment functionality of 2.68 and a system functionality of 2.54. When this composition is used to produce a textile coating composition, it produced a film having a film drape of 1.875 inches, a Shore A Durometer of 71, a tear strength of 102.60 lbs per linear inch, a tensile strength of 627.03 psi (as measured according to ASTM 35.74), an elongation of 113.87% (at break) and a density of 67.04 lbs/ft³. This composition is believed not preferably suitable for use in certain broadloom carpet or carpet tile applications in accordance with the present invention, because the film drape is not greater than or equal to about 2 inches.

### EXAMPLE 3

A carpet tile coating composition is prepared from the ingredients shown in Table 7 below.

TABLE 7

| Ingredient | Parts by weight |
|---|---|
| Dry Castor oil | 90 |
| Glycol ether DB | 10 |
| Isonate 143L | 47.39 |
| Tin catalyst UL-29 | 0.05 |

Glycol ether DB is diethyleneglycol monobutyl ether, available from Ashland Chemical.

This composition has a soft segment functionality of 2.36 and a system functionality of 2.20. When this composition is used to produce a textile coating composition, it produces a film having a film drape of 3.250 inches, a Shore A Durometer of 54, a tear strength of 70.17 lbs per linear inch, a tensile strength of 251.06 psi, an elongation of 146.83%, and a density of 68.45 lbs/ft³. This composition is believed suitable for use in both broadloom carpet and carpet tile applications.

### EXAMPLE 4

A coating composition is prepared from the ingredients shown in Table 8 below.

TABLE 8

| Ingredient | Parts by weight |
|---|---|
| Dry Castor oil | 90 |
| Glycol ether DB | 10 |
| PAPI 94 | 44.11 |
| Tin catalyst UL-29 | 0.05 |

This composition has a soft segment functionality of 2.36 and a system functionality of 2.38. When this composition is used to produce a textile coating composition, it produces a film having a film drape of 2.750 inches, a Shore A Durometer of 58, a tear strength of 72.09 lbs per linear inch, a tensile strength of 247.01 psi, an elongation of 90.28%, and a density of 68.00 lbs/ft³. In a second test, it produces a film having a film drape of 2.875 inches, a Shore A Durometer of 60, a tear strength of 71.25 lbs per linear inch, a tensile strength of 239.16 psi, an elongation of 83.43%, and a density of 67.78 lbs/ft³. This composition is believed suitable for use in both broadloom carpet and carpet tile applications.

### EXAMPLE 5

A coating composition is prepared from the ingredients shown in Table 9 below.

TABLE 9

| Ingredient | Parts by weight |
|---|---|
| Dry Castor oil | 85 |
| Glycol ether DB | 15 |
| Isonate 143L | 49.76 |
| Tin catalyst UL-29 | 0.05 |

This composition has a soft segment functionality of 2.22 and a system functionality of 2.14. When this composition is used to produce a textile coating composition, it produces a film having a film drape of 3.625 inches, a Shore A Durometer of 53, a tear strength of 58.76 lbs per linear inch, a tensile strength of 209.03 psi, an elongation of 195.49% and a density of 68.74 lbs/ft³. This composition is believed suitable for use in both broadloom carpet and carpet tile applications.

### EXAMPLE 6

A coating composition is prepared from the ingredients shown in Table 10 below.

TABLE 10

| Ingredient | Parts by weight |
|---|---|
| Dry Castor oil | 85 |
| Glycol ether DB | 15 |
| PAPI 94 | 46.31 |
| Tin catalyst UL-29 | 0.05 |

This composition has a soft segment functionality of 2.22 and a system functionality of 2.31. When this composition is used to produce a textile coating composition, it produces a film having a film drape of 3.250 inches, a Shore A Durometer of 51, a tear strength of 52.00 lbs per linear inch, a tensile strength of 136.33 psi, an elongation of 78.28% and a density of 67.34 lbs/ft³. This composition is believed suitable for use in both broadloom carpet and carpet tile applications.

### EXAMPLE 7

A coating composition is prepared from the ingredients shown in Table 11 below.

TABLE 11

| Ingredient | Parts by weight |
|---|---|
| Dry Castor oil | 80 |
| Glycol ether DB | 20 |
| Isonate 143L | 52.13 |
| Tin catalyst UL-29 | 0.05 |

This composition has a soft segment functionality of 2.10 and a system functionality of 2.07. When this composition is used to produce a textile coating composition, it produces a film having a film drape of 3.975 inches, a Shore A Durometer of 37, a tear strength of 22.55 lbs per linear inch, a tensile strength of 72.06 psi, an elongation of 258.83% and a density of 67.49 lbs/ft³. This composition is believed not preferably suitable for use in selected broadloom carpet or carpet tile applications in accordance with the present invention, because the Shore A Durometer is less than 50.

### EXAMPLE 8

A coating composition is prepared from the ingredients shown in Table 12 below.

TABLE 12

| Ingredient | Parts by weight |
|---|---|
| Dry Castor oil | 80 |
| Glycol ether DB | 20 |
| PAPI 94 | 48.52 |
| Tin catalyst UL-29 | 0.05 |

This composition has a soft segment functionality of 2.10 and a system functionality of 2.25. When this composition is used to produce a textile coating composition, it produces a film having a film drape of 3.625 inches, a Shore A Durometer of 45, a tear strength of 45.94 lbs per linear inch, a tensile strength of 100.99 psi, an elongation of 93.57% and a density of 67.22 lbs/ft³. This composition is believed not preferably suitable for use in selected broadloom carpet or carpet tile applications because it has a Shore A Durometer of less than 50.

### EXAMPLE 9

The following coating composition is prepared from the ingredients shown in Table 13 below.

TABLE 13

| Ingredient | Parts by weight |
|---|---|
| Dry Castor oil | 55 |
| Texanol | 12 |
| V9240 | 33 |
| WF-75 | 160 |
| Catalyst | 0.02 |
| Isonate 143L | 33.35 |
| Total Parts by Weight | 293.02 |

In the foregoing formula, Texanol is 2,2,4-trimethyl-1,3-pentanediol monoisobutyrate (CAS No. 25265-77-4) available from Eastman Chemical Co. and having a true functionality of 1.0 and an equivalent weight of 216.32; V9240 is polyether polyol available from Dow Chemical Co. and having a true functionality of 1.70 and an equivalent weight of 1960; and WF-75 is calcium carbonate filler available from Georgia Marble Co. This composition has a soft segment functionality of 2.21 and a system functionality of 2.13.

### EXAMPLE 10

The following coating composition is prepared from the ingredients shown in Table 14 below.

TABLE 14

| Ingredient | Parts by weight |
|---|---|
| Dry Castor oil | 55 |
| Texanol | 12 |
| V9240 | 33 |
| PV-20A | 250 |
| Catalyst | 0.02 |
| PAPI 94 | 31.04 |
| Total Parts by Weight | 381.02 |

In the foregoing formula, PV-20A is coal fly ash filler available from Boral Material Technologies. This composition has a soft segment functionality of 2.21 and a system functionality of 2.30.

### EXAMPLE 11

The following coating composition is prepared from the ingredients shown in Table 15 below.

TABLE 15

| Ingredient | Parts by weight |
|---|---|
| Dry Castor oil | 45 |
| Marlasol 100 | 14 |
| V9287 | 41 |
| WF-75 | 160 |
| Catalyst | 0.02 |
| PAPI 94 | 26.36 |
| Total Parts by Weight | 296.02 |

In the foregoing formula, Marlasol 100 is an ethoxylated nonylphenol available from Lenmar Chemical Corp. and having a true functionality of 1.00 and an equivalent weight of about 659; V9287 is polyether diol available from Dow Chemical Co. and having a true functionality of 1.75 and an equivalent weight of 1018. This composition has a soft segment functionality of 2.38 and a system functionality of 2.36.

### EXAMPLE 12

The following coating composition is prepared from the ingredients shown in Table 16 below.

TABLE 16

| Ingredient | Parts by weight |
|---|---|
| Dry Castor oil | 52 |
| Marlasol 100 | 15 |
| V9287 | 33 |
| PV-20A | 250 |
| Catalyst | 0.02 |
| PAPI 94 | 27.6 |
| Total Parts by Weight | 377.62 |

This composition has a soft segment functionality of 2.35 and a system functionality of 2.37.

### EXAMPLE 13

The following coating composition is prepared from the ingredients shown in Table 16 below.

TABLE 17

| Ingredient | Parts by weight |
|---|---|
| Dry Castor oil | 55 |
| Glycol Ether DB | 12 |
| V9240 | 33 |
| WF-75 | 160 |
| Catalyst | 0.02 |
| Isonate 143L | 36 |
| Total Parts by Weight | 296.02 |

This composition has a soft segment functionality of 2.12 and a system functionality of 2.09.

### EXAMPLE 14

The following coating composition is prepared from the ingredients shown in Table 18 below.

TABLE 18

| Ingredient | Parts by weight |
|---|---|
| Dry Castor oil | 55 |
| Glycol Ether DB | 12 |
| V9240 | 33 |
| PV-20A | 250 |
| Catalyst | 0.02 |
| PAPI 94 | 33.51 |
| Total Parts by Weight | 383.53 |

This composition has a soft segment functionality of 2.12 and a system functionality of 2.26.

### EXAMPLE 15

The following coating composition is prepared from the ingredients shown in Table 19 below.

TABLE 19

| Ingredient | Parts by weight |
|---|---|
| Dry Castor oil | 55 |
| V9240 | 45 |
| WF-75 | 160 |
| Catalyst | 0.04 |
| Isonate 143L | 26.28 |
| Total Parts by Weight | 286.32 |

This composition has a soft segment functionality of 2.56 and a system functionality of 2.30.

### EXAMPLE 16

The following coating composition is prepared from the ingredients shown in Table 20 below.

TABLE 20

| Ingredient | Parts by weight |
|---|---|
| Dry Castor oil | 55 |
| V9240 | 45 |
| PV-20A | 250 |
| Catalyst | 0.04 |
| Isonate 143L | 26.28 |
| Total Parts by Weight | 286.32 |

This composition has a soft segment functionality of 2.56 and a system functionality of 2.30.

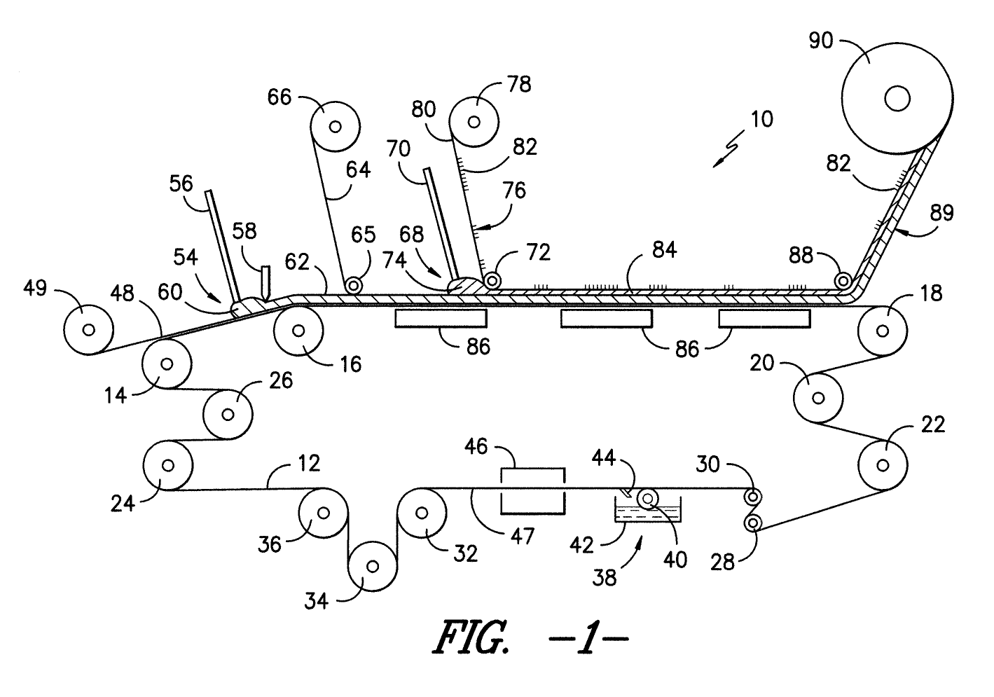

Referring now in more detail to the drawings in which like numbers indicate like elements throughout the several views, there is shown in FIG. 1 an exemplary apparatus 10 for forming or applying a layer of elastomeric polyurethane on or to, for example, a textile, fabric, or other material. The apparatus 10 includes an endless belt 12 extending along an endless conveyor path over the rollers 14, 16, 18, 20, 22, 24 and 26 of which some are driven by an electric motor (not shown), the idler rollers 28 and 30, and the belt tensioning rollers 32, 34 and 36 (FIG. 1). The belt 12 moves in a continuous loop in the direction shown by the arrows (FIG. 1). The speed of the belt 12 is preferably variably controllable to adjust to varying manufacturing needs, for continuous or intermittent production or the like. Generally, for producing coated carpet products, belt speeds that are useful in the present invention may preferably be about 8 to about 80 feet per minute, especially, preferably about 10 to about 60 feet per minute. Other speeds can also be used depending on the product that is being manufactured, the number of layers, the thickness, the type and amount of heat or catalyst being used, and/or the like.

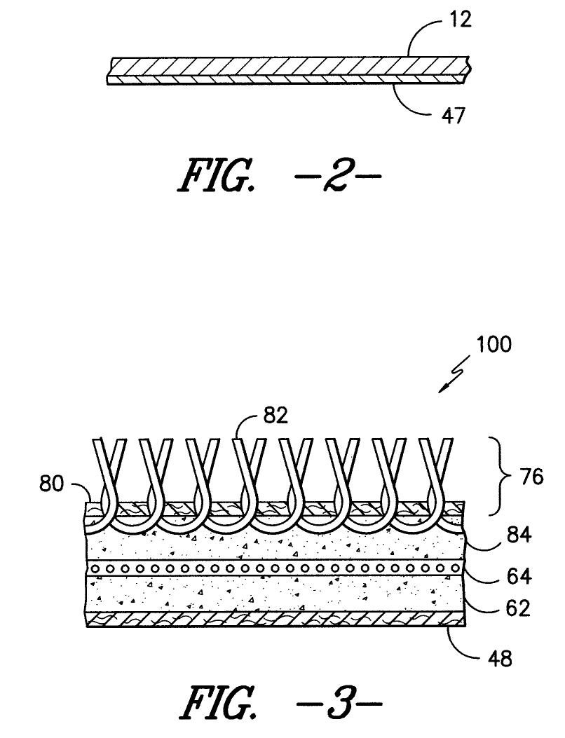

From the roller 14, the belt 12, which preferably is constructed from fiberglass coated with a low coefficient of friction coating, such as Teflon® (polytetrafluoroethylene), passes around the rollers 16, 18, 20 and 22. The belt 12 is delivered by the idler rollers 28 and 30 to an optional film coating station 38 having, for example, an applicator roller 40 partially submerged in a liquid elastomeric composition mixture in a trough 42. The mixture may preferably comprise an ethylene vinyl acetate latex, surfactants, a thickener, a flame retardant, and an internal lubricant. A doctor blade 44 is shown positioned downstream of the applicator roller 40 to control the thickness of the film as it is coated onto the belt 12 by wiping off any excess which then flows down the blade back into the trough 42. The optional film 47 on the coated belt 12 (FIGS. 1 and 2) is then dried in a circulating hot air dryer 46. The optional dried elastomeric film 47 has, for example, a thickness of about 0.0005 inches to about 0.002 inches, preferably about 0.001 inch and a weight per square yard of about 0.4 ounces to about 2 ounces, preferably about 0.9 ounces per square yard. An optional belt cleaning brush (not shown) may be added upstream of the optional film coater 38. Alternately, the optional elastomeric film 47 can comprise a layer of a preformed olefin material, such as polyethylene or polypropylene, or a layer of polyvinyl chloride or rubber lattices, such as natural or synthetic styrene-butadiene rubber (SBR) latex. In addition, the elastomeric film 47 can be extruded onto the belt rather than formed in situ. Alternately or additionally, an optional fabric, textile, substrate, carrier, film, sheet or material, such as a light weight nonwoven felt, mat or scrim 48 (release material) can be substituted for or added over the optional elastomeric film 47 by, for example, laying the fabric or scrim 48 from a supply roll 49 onto the belt 12 as it passes around the roller 14. The optional fabric 48 may be, for example, a woven, nonwoven, needled, calendered or knitted construction, such as a polyester and/or polypropylene fiber felt, a woven fiber polypropylene (Polybac), a nonwoven bonded fiber polypropylene mesh or scrim (Actionbac), a nonwoven glass mat, a calendered woven fiber polypropylene, a non-calendered woven fibrous polypropylene, woven polypropylene FLW (calendered or non-calendered), single or multi-layer films, materials, fabrics, or textiles such as woven layers and nonwoven layers needlepunched and/or calendered together, for example, a woven ribbon polypropylene with a nonwoven fiber polyester layer needled thereto and optionally including low melt polyester fibers calendered and fused thereto, nonwoven primary backing materials such as Lutradur or Colback, secondary backing materials such as Mattex, Polybac or Actionbac, films such as a polyester film, a polyurethane film, a polyethylene film, a polypropylene film, a polyamide film (Nylon film), a high coefficient of friction (COF) film, sheet material such as paper (coated or uncoated), such as wax paper or Kraft paper, triaxial scrims (such as Stabilon scrims by Milliken & Company of Spartanburg, S.C.), glass scrims, or the like and can be made from natural or synthetic fibers, materials, or blends thereof, and preferably includes recycled content. A fabric or material 48 having a controlled or slight shrinkage under heat may be preferred as it may provide a slight doming to a tile product. For example, a polyester felt with some polypropylene therein will tend to shrink slightly when heated.

From the drier 46, the belt 12 with the optional dried elastomeric film 47 thereon is then passed over the tensioning rollers 32, 34 and 36 to properly tension the belt. Then, the belt 12 is passed over the rollers 24 and 26 and back to the roller 14.

Downstream from the roller 14 is an optional first polyurethane deposition station 54. The polyurethane deposition station 54 includes two reactant reservoirs (not shown) and a reactant mixer (not shown) for the A-side and B-side of the polyurethane reactant composition in accordance with the disclosed embodiments and a flexible discharge hose 56 extending above the belt 12. In order to assure a uniform lay down of the polyurethane reactants onto the film 47 coated belt or fabric 48, the end of the hose 56 is preferably positioned about 0.25 inch to about 6 inches, more preferably about 2.0 inches above the belt 12. Additionally, the centerline of the hose 56 is preferably positioned about 1 inch to about 10 inches, more preferably about 3 inches, upstream from a spreading device or doctor blade 58. The polyurethane reactants are deposited from the lower end of hose 56 on to the film-coated belt or fabric 48 in an amount such that they form a puddle or rolling bank 60 in front of the doctor blade 58. The deposited polyurethane reactant mixture is then smoothed and spread into a first reactive layer 62 of uniform thickness by the doctor blade 58 positioned at a desired distance above the belt 12. The polyurethane reactant mixture is preferably formed into a layer 62 of about 0.05 to about 0.25 inches thick; especially, preferably about 0.06 to about 0.12 inches thick when layer 62 is an elastomer or non-blown, non-cellular, non-foam layer. If layer 62 is a foam, blown, or cellular layer, or if layer 62 is filled with large filler particles such as foam chips, recycled flooring chips, and/or the like, preferred thicknesses may be about 0.06 to about 0.50 inches thick; especially, preferably about 0.07 to about 0.37 inches thick. The thickness of the optional first layer 62 may also depend, for example, in part on the thickness of the second layer 84, the function or purpose of the first layer, the product being formed, and/or the like. First and second layers 62 and 84 may be of different compositions or formulations. For example, first layer 62 may be foam and second layer 84 may be non-foam.

Simultaneously with the deposition of the polyurethane reactants onto the belt 12, an optional stabilizing or reinforcing layer, such as a textile, fabric, or substrate 64, such as a nonwoven fiberglass mat, is optionally dispensed from a supply roll 66. The optional fabric 64 can be of any desired construction, such as a woven, nonwoven or knitted construction and can be made from natural or synthetic fibers or a blend thereof. The optional fabric 64 is shown fed under a marriage bar or roller 65 to tension and marry the fabric 64 to the first layer 62 of polyurethane reactants. The optional fabric 64 may be fed under, on, in or over first layer 62 or second layer 84. Also, additional optional fabrics 64 may be added under, on, in, or over first layer 62 and/or second layer 84. As a nonwoven glass mat may be weak in the z-direction if not fully saturated, it may be preferred that if fabric 64 is a nonwoven glass mat, such as an about 1 or 2 oz/yd² glass mat, that it be fully saturated by or embedded in layer 62, layer 84, or both.

Downstream from the marriage bar 65 is a second polyurethane deposition station 68. The second polyurethane deposition station 68 includes two reactant reservoirs (not shown) and a reactant mixer (not shown) for the A-side and B-side of the polyurethane reactant composition in accordance with the disclosed embodiments and a flexible discharge hose 70 extending above the optional film 47, fabric 48, first reactive layer 62, and fabric 64 on the belt 12. In order to assure a uniform lay down of the polyurethane reactants onto the optional fabric 64, the lower end of the hose 70 is preferably positioned about 0.25 inch to about 6 inches, more preferably about 2.0 inches above the optional fabric 64 or first layer 62. Additionally, the centerline of the hose 70 is preferably positioned about 1 inch to about 10 inches, more preferably about 3 inches, upstream from a marriage bar or roller 72. The polyurethane reactants are preferably deposited on the optional fabric 64 in an amount such that they form a puddle or rolling bank 74 in front of the marriage bar 72.

A textile, fabric or other material 76, such as a flooring or non-flooring fabric is dispensed from a supply roll 78. In at least selected embodiments, the fabric 76 may be carpet fabric, greige fabric, or greige goods face material 76 of a flooring product, for example, a tufted, woven, nonwoven, bonded, flocked, needled, knitted, needle punched, and/or similar construction face material dispensed from the supply roll 78. The fabric 76 may be tufted greige goods and include, for example, a backing fabric, primary backing or tufting substrate 80 and outwardly extending yarns 82 which form the pile face of the carpet (FIGS. 1 to 3). Although it may be preferred that fabric 76 is unbacked greige goods, the fabric or textile 76 can be backed or unbacked carpet (with or without a pre-coat or a secondary backing). The textile or fabric 76, primary backing or tufting substrate 80, and outwardly extending yarns 82 can be made from natural or synthetic fibers or blends thereof. For example, the face fabric 76 may be made of Nylon 6,6 yarn 82 and a nonwoven, polypropylene primary backing 80.

The fabric or carpet 76 is then fed under the marriage bar 72 to tension and/or deposit the fabric or carpet on the polyurethane reactants. The marriage bar 72 is set at a desired height above the belt 12 so that as the fabric 76 moves under the marriage bar, it forms the puddle 74 of urethane reactants into a second layer 84 of a desired thickness. The polyurethane reactant mixture is preferably formed into a second layer 84 of about 0.04 to about 0.25 inches thick; especially, preferably about 0.06 to about 0.12 inches thick. The thickness of the second layer 84 depends, for example, in part on the thickness of the first layer 62, the desired total thickness of the combined layers, the function or purpose of the second layer, the product being formed, and/or the like. If, for example, layer 84 is the precoat and layer 62 is the cap coat, backing, cushion, or secondary backing, then layer 84 may be thinner, less filled, and/or less viscous than layer 62. If in another example, layer 84 is a combined precoat and backing, then there may be no layer 62 (0 inches thick) and layer 84 may be about 0.2 inches thick. If in yet another example, layer 62 is a combined precoat and backing, then there may be no layer 84 (0 inches thick) and layer 62 may be about 0.2 inches thick. Also, if layer 84 is a foam, blown, or cellular layer, or if layer 84 is filled with large filler particles such as foam chips, recycled flooring chips, and/or the like, preferred thicknesses for layer 84 may increase to about 0.06 to about 0.50 inches thick; especially, preferably about 0.07 to about 0.37 inches thick.

Before, during and/or after the fabric or carpet 76 is applied to the layer 84 of polyurethane reactants, the composite may be heated to cure the polyurethane reactants of layers 62 and/or 84. This may be accomplished by passing the composite comprising the carpet 76, the top layer 84 of polyurethane reactants, the optional fabric 64, the bottom layer of polyurethane reactants 62, and film 47 and/or fabric 48 over the heaters or heated platens 86 which raise the temperature of the polyurethane reactants sufficiently to cure them, such as preferably about 150° to 350° F.; more preferably about 250° to 300° F. Each of the heaters 86 may be operated at a different temperature depending on the type of product or properties desired. Also, cooling or fan elements or equipment (not shown) may be used to cool the product or composite to room temperature, for example, in the final stages of product formation, prior to cutting, prior to rolling, or the like.

Finally, the textile, fabric or material face 76, together with the attached layer or layers of polyurethane and fabric or materials, is stripped from the belt 12 by passing the composite or precursor 89 over a stripper roller 88 and rolled onto a take-up reel 90 (as product or to be slit trimmed or cut later) or sent to a cutter (not shown) to be slit, trimmed, or cut into products such as tiles, rugs, runners, or the like.

With reference to FIG. 2, there is shown an enlarged side view of belt 12 and of attached optional release film or other material layer 47.

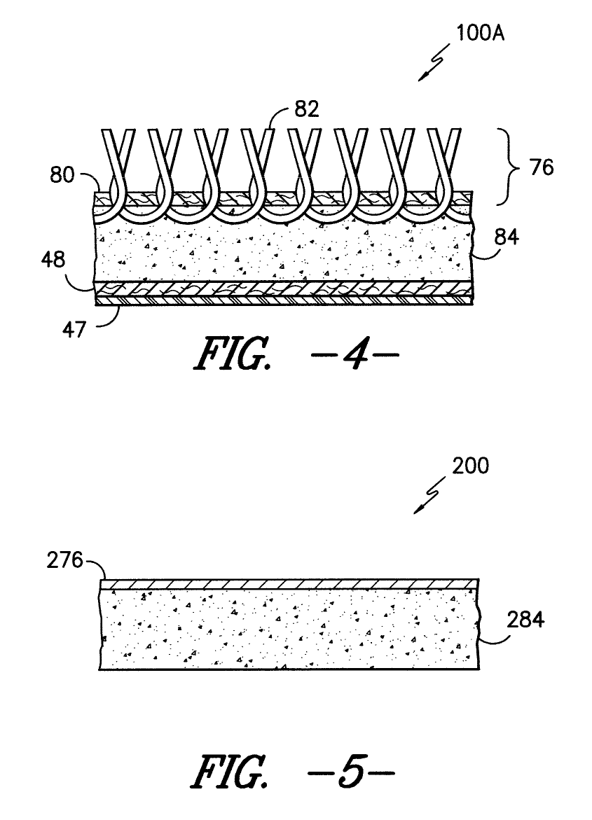

With reference to FIG. 3, it will be seen that there is a side cross-sectional view of an exemplary carpet product 100 produced as described above. The carpet product 100 comprises tufted carpet face 76, the second layer 84 of polyurethane, the layer of fabric 64, the first layer of polyurethane 62, and the fabric 48. Fabric 48 may be replaced with film 47 or may have film 47 added thereto (for example, see FIGS. 4, 5 and 11). Additional layers, fabrics, or materials, such as elastomer, foam, fabric, material, and/or the like can be adhered to, or placed in, on, over, and/or under the film 47, fabric 48, layer 62, material 64, or layer 84, as desired.

As stated above, the fabric 64, the layer 62, the fabric 48, and the film 47 are each optional. Therefore, a select or particular product embodiment of the present invention can be practiced by merely applying the polyurethane composition as a coating on a fabric, in which case a carpet product 100A may appear as shown in FIG. 4 and would comprise the tufted carpet 76, the layer 84 of polyurethane, the fabric 48, and the film 47. Bear in mind that film 47 and fabric 48 are optional and may each be included or excluded from product 100A. Although a tufted cut pile fabric 76 is shown in FIGS. 1 to 3, it is understood that the face fabric, textile or material 76 may have a variety of constructions, orientations, or the like, including but not limited to, pile, non-pile, loop pile, cut and loop pile, level loop, multi-level loop, Saxony, sisal, textured, graphics tufted, jet dyed, patterned, pattern textured, printed, plush, nap, frieze, Berber, woven, nonwoven, bonded, flocked, needled, knitted, needle punched, calendered, tufted, and/or the like. For example, it has been known for certain flooring products to be made by inverting the face fabric and to thereby use the typical bottom (technical back) of the fabric as the face or top. Even when producing a flooring product, fabric 76 may or may not be a typical flooring face material or construction.

Other methods of coating textiles, fabrics, carpets, backings, and the like can also be used in accordance with disclosed embodiments of the present invention. For example, the method of coating a carpet fabric backing disclosed in U.S. Pat. Nos. 6,203,881 and 6,468,623 (the disclosures of which are both incorporated herein by reference) can also be used.

The polyurethane compositions of the present invention may be used to prepare flooring products and non-flooring products. As used herein, flooring products include, but are not limited to, carpet tile, modular carpet, roll goods, broadloom carpet, attached cushion broadloom carpet, stabilized broadloom carpet, six foot goods, two meter goods, rugs, area rugs, runners, mats, floor mats, and the like. As used herein, non-flooring products include all other products not used for flooring. It is specifically contemplated that the disclosed embodiments of the polyurethane compositions can be used to coat textiles, fabrics or other materials for use in flooring products or for use in products other than flooring, such as textiles or fabrics for clothing, upholstery, contract fabrics, water barriers, tents, and the like.

With reference to FIG. 5, it will be seen that there is a side cross-sectional view of a textile or fabric product 200 for use in non-flooring applications (and which could be formed, for example, on the apparatus of FIG. 1). The product 200 includes, for example, a fabric layer 276 with a layer of polyurethane 284 attached thereto. The fabric layer 276 is of a woven, nonwoven, bonded, flocked, needled, knitted, needle punched or similar construction, suitable for use in non-flooring products. The layer of polyurethane 284 is made from a polyurethane composition including but not limited to castor oil, monol, and isocyanate in accordance with certain disclosed embodiments of the present invention, as described herein.

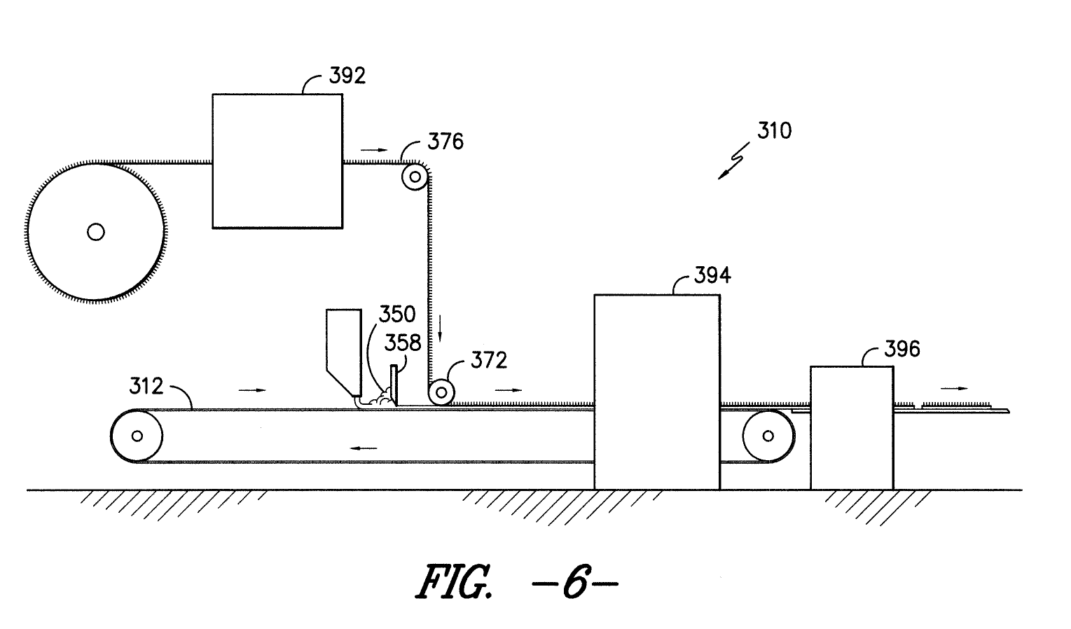

Referring to FIG. 6 of the drawings, another exemplary formation system 310 is illustrated for use in the production of surface coverings, for example, polyurethane backed floor coverings or flooring products such as carpeting, carpet tile, area rugs, roll goods, floor mats, and/or the like, or non-flooring products. According to the illustrated and potentially preferred embodiment, the formation system 310 includes an endless belt 312 formed from a material such as PTFE woven fiberglass or the like. As shown according to the illustrated process, a mass of preferably uncured, liquid (pourable, flowable) polyurethane composition 350 is preferably deposited directly onto the belt 312 and then adjusted to a desired height by a leveller 358 such as a doctor blade, air knife, or the like. The thickness of the levelled polyurethane composition may preferably be in the range of about 0.01 inch to about 1 inch (depending on, for example, if the polyurethane is a precoat, tiecoat, cap coat, secondary backing, binder, cushion and/or adhesive, foam or non-foam composition, hardback or cushion backing, or the like) although higher or lower thickness levels may likewise be used. While direct application of the polyurethane composition onto the belt 312 may be preferred, it is likewise contemplated that a release layer, film, paper, backing, or the like on or over the belt or other deposit surface may likewise be used if desired.

By way of example only, one contemplated possibly preferred polyurethane composition includes, for example, castor oil (a natural polyol), monol, isocyanate (such as an MDI or MDI blend), catalyst, and filler (such as coal fly ash (CFA)), together with one or more other fillers, agents, additives, extenders, and the like, such as diols, chain terminators, chain extenders, drying agents, viscosity enhancers, flow agents, and/or the like. The polyurethane composition may be made without a catalyst (may still cure sufficiently to be handled in about 30 minutes or less without a catalyst when heated during curing and may still cure sufficiently in about 60 minutes or less without a catalyst when no heat is added during curing).

Example Product Process:

A wet film of polyurethane composition is formed on a belt and weighs from about 45 to about 120 ounces per square yard (oz/yd²), preferably from about 60 to about 95 oz/yd², more preferably from about 65 to about 80 oz/yd². A carpet face material is laid onto the wet film. Pressure may be applied to the carpet-polyurethane assembly, ranging from, for example, about 0 to about 1 pounds per square inch (psi), preferably from about 0 to about 0.5 psi, more preferably from about 0 to about 0.25 psi, depending on the carpet used (for example, carpet weight, greige goods or backed carpet, etc.), mating, marriage, or nip roll or bar used, polyurethane viscosity, cure rate, gel rate, pre-heating, and/or the like. The film and carpet assembly may also be heated, for example, from below by platens, from about room or ambient temperature to about 300° F., preferably from about room or ambient temperature to about 275° F., more preferably from about 250° F. to about 275° F.

Other exemplary fillers, agents, additives, extenders, and the like, may include, for example, calcium carbonate, sand, foundry sand, used foundry sand, clay, crushed glass, crushed recycled glass, post-consumer recycled glass, glass particles, glass fibers, bone, bone meal, metal, recycled metal, iron, steel, ferrite, magnetite, iron oxides, barite, nickel, fillers with a specific gravity (SG) greater than 2, fillers with a specific gravity greater than 5, inert oil, rubber, recycled rubber, SBR particles, mixed fines glass, mixed course glass, crushed bone meal, crushed gypsum, barium sulphate, foam chips, recycled flooring products, recycled carpet tile, recycled polyurethane, natural and/or synthetic fibers, colorants, anti-microbial agents, flame retardants, blowing agents, other catalysts, other polyols, other isocyanates, water, recycled materials, renewable materials, bio-based materials, post-consumer recycled materials, post-industrial recycled materials, natural materials, recyclable materials, blends thereof, combinations thereof, and/or the like. Fillers (including blends or combinations of fillers) may be added at amounts of, for example, about 0% to about 95% by weight, preferably about 10% to about 80% by weight, and more preferably from about 50% to about 75% by weight of the polyurethane composition. Fillers, agents, additives, extenders, liquids, and/or the like may be added in combination with air (or other gases) mixing or frothing and/or blowing to provide density levels, ease of coating, cushioning, and/or the like as desired.

In accordance with one example of a flexible, polyurethane hardback carpet tile (or roll goods) having a construction like that of FIG. 7 of the drawings, the preferred, filled, polyurethane backing which serves as both precoat and backing is a mechanically mixed, filled, castor oil, monol, and methyl diphenyl diisocyanate (MDI) based polyurethane, the preferred total finished product weight is about 90 to about 100 oz/yd², the preferred tuftbind is greater than about 10 pounds (lbs), more preferably about 12 to about 15 lbs, the preferred total finished product thickness is about 0.1 to about 0.4 inches, more preferably about 0.15 to about 0.35 inches, still more preferably about 0.225 inches, preferably no stabilizing layer (no glass mat or scrim) in addition to the face material and polyurethane backing, the preferred Velcro test tolerance is at least about 3.0, more preferably at least about 4.0, still more preferably at least about 4.5 (on a 1 to 5 rating scale), the preferred tuftbind minimum tolerance is at least about 8 lbs of force (lbs), more preferably at least about 10 lbs, still more preferably at least about 15 lbs, the preferred face material is a tufted, Nylon 6,6, greige goods face having a preferred face weight of less than about 20 oz/yd², made from a non-heatset singles yarn preferably with a denier of about 1000-1400, with an about 100 grams per square meter (gm/m²) nonwoven primary backing (tufting substrate), for example, a 100 gm/m² Colback nonwoven, spunbond polyester with a Nylon sheath, and the preferred product bending modulus (flexibility) is less than about 5 ksi, more preferably less than about 4 ksi, still more preferably less than about 3 ksi (where ksi is 1,000 psi).

By adding a catalyst and heat, the polyurethane backing can preferably be cured to the point of handling in about 5 to about 30 seconds, preferably about 10 to about 20 seconds, most preferably about 15 seconds. Curing depends on the catalyst used, heat applied during processing, range speed, backing thickness, filler load, and the like. It is noted that one or more catalysts may be used, the catalyst is optional, heat is optional, and the like.

An acrylic latex belt release material, agent or layer may be added on or over the belt, such as a PTFE belt.

As illustrated in FIG. 6, once the polyurethane composition 350 is set to a desired level, a textile face structure 376 with a fibrous underside is preferably delivered into direct contacting relation with the polyurethane composition. Preferably, no intermediate layer is disposed between the polyurethane and the underside of the textile face structure (see FIGS. 7 to 10). According to one contemplated practice, the textile face structure 376 (such as tufted greige goods) may be pre-treated or pre-stabilized at a steam box 392 (or dryer or oven) to relieve internal stresses by, for example, application of moisture and heat, such as by heating under no to low tension at about 210 to about 320° F., more preferably at about 240 to about 290° F., still more preferably at about 270° F., preferably for about 20 seconds to about 15 minutes, more preferably from about 45 seconds to about 10 minutes, and still more preferably from about 2 minutes to about 8 minutes, alternatively, the face material 376 may be pre-treated by being dyed, such as by being range jet dyed, dried, heated, and/or the like. Such treatment permits the face structure 376 to remain substantially tensionless during subsequent curing of the polyurethane composition 350 as will be described further hereinafter. The elimination of tensions, contractions and/or expansions in the face structure 376 facilitates the avoidance of undue levels of cupping or curling in the final structure. It is preferred that the polyurethane backing be relatively thin, dense, and flexible and that the face material or fabric be substantially tensionless. Such a product lies flat on the floor, can be bent or rolled, and the like. The face material 376 may also be preheated and/or dried inline by, for example, an oven, IR heaters, heated plates, and/or the like.

Following introduction of the textile face structure 376 across the polyurethane composition 350, the resulting composite structure or assembly may go through a marriage roll or bar 372 or the like and thereafter may be moved through, for example, an elevated temperature curing range 394. The temperature in the curing range is preferably set to provide substantially complete curing of the polyurethane composition 350 or to provide at least sufficient curing to handle the composite. By way of example only and not limitation, such a curing range 394 having, for example, heated platens below belt 312, a platen temperature setting of about 250° F. in a first zone, and with a setting of about 290° F. in subsequent zones may provide good curing results when the belt 12 is operating at a rate of about 30 feet per minute. Of course, these setting may be readily adjusted as desired. For example, certain polyurethane backings may cure sufficiently to handle at room temperature (no heat required).

As shown, upon exiting the curing range 394, the composite structure with cured polyurethane (or partially cured polyurethane) may thereafter be removed from the belt 312 and sent to a cutter 396 for segmentation to a length and width as desired based on the final intended use or rolled to be cut later. Cutter 396 may be a clicker for carpet tiles, a cut table for mats or rugs, a slitter, an ultrasonic, laser, air, or water cutter, or the like. Accordingly, the formation system 310 may be used to form carpet, carpet tile, area rugs, roll goods, and/or floor mats as may be desired. In this regard, it is to be understood that the density and thickness levels of polyurethane may be adjusted depending upon the product being produced. As an example, it is contemplated that the mass per unit area of polyurethane may be slightly higher for carpeting than for floor mats. By way of example only, a polyurethane mass per unit area of about 26 to 28 ounces per square yard with a thickness of about 63 mils may be suitable for certain carpeting while a mass per unit area of about 25 ounces per square yard with a thickness of about 100 mils may be more suitable for certain dust control mats.

As previously noted, the textile face structure 376 may have any number of suitable constructions. By way of example only, FIGS. 7 to 10 illustrate a number of polyurethane-backed constructions such as may be formed on the system 310 using various face structures.

FIG. 7 illustrates a product or composite 300 having a tufted textile face structure 376 incorporating an arrangement of yarn elements 382 tufted through a so called “primary backing” 380 such as a woven material, a scrim, a non-woven material, combined woven and non-woven material, or the like. As shown, the cured polyurethane composition 350 extends substantially to the primary backing 380 thereby aiding in locking the yarn elements 382 in place. Although a level loop pile is shown, the pile may be level or textured (multilevel) loop, cut, cut and loop pile, or the like.

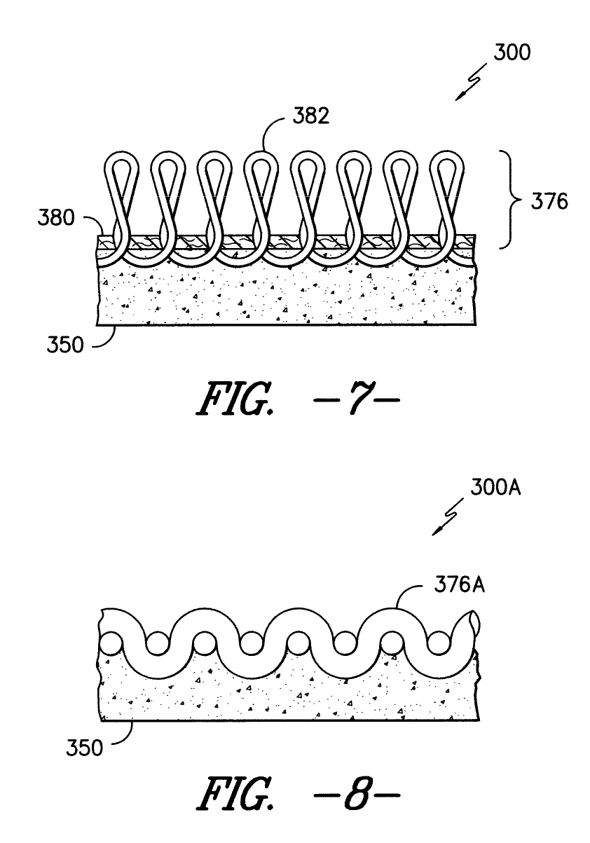

FIG. 8 illustrates a product or composite 300A having a woven textile face structure 376A disposed in contacting relation to the cured polyurethane composition 350. As shown, the cured polyurethane composition 350 extends substantially to the lower surface of the woven textile face structure 376A and preferably migrates at least partially into the interstices between yarn elements forming the woven textile face structure 376A to promote good adhesion.

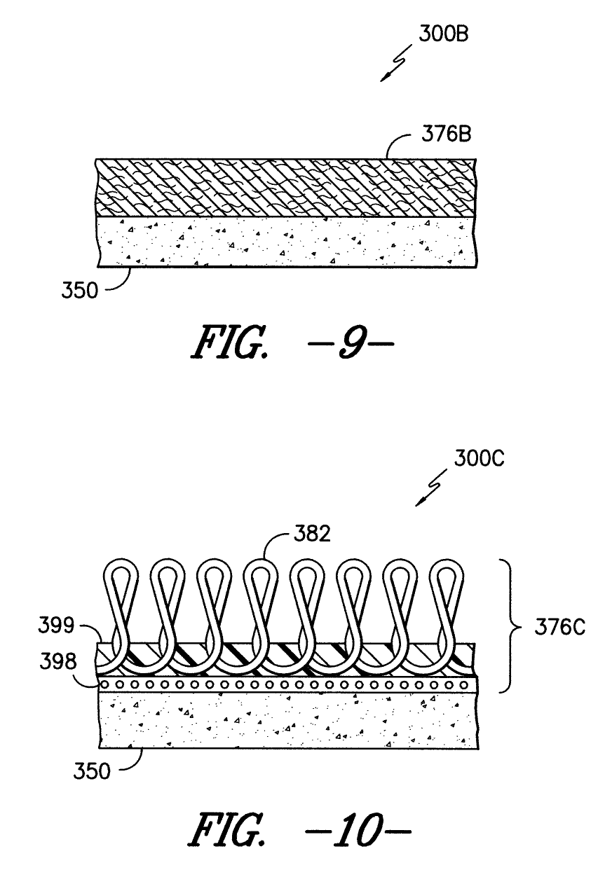

FIG. 9 illustrates a product or composite 300B having a non-woven textile face structure 376B such as a needlepunched, calendered, flocked, spunbond, wet laid, or other non-woven construction disposed in contacting relation to the cured polyurethane composition 350. As shown, the cured polyurethane composition 350 extends substantially to the lower surface of the non-woven textile face structure 376B and preferably migrates at least partially into the interstices between the lower fiber elements forming the non-woven textile face structure 376B to promote good adhesion.

FIG. 10 illustrates a product or composite 300C having a bonded carpet or bonded yarn textile face structure 376C incorporating an arrangement of yarn or pile elements 382 bonded in place across a primary backing or substrate layer 398 by an adhesive 399 disposed across at least the upper surface of the primary backing layer 398. Although a level loop pile is shown, the pile may be level or textured loop, cut, or cut and loop pile. As shown, the cured polyurethane composition 350 preferably extends substantially to the primary backing 398. Although adhesive layer 399 may be a latex adhesive as used in latex bonded carpet, adhesive layer 399 may also be a polyurethane composition in accordance with at least a selected embodiments of the present invention including castor oil, monol, isocyanate, and other optional catalyst, filler, additives, and/or the like.

As indicated previously, it is also contemplated that one or more backing or release layers may be applied across the underside of the cured polyurethane facing away from the textile face structure. It is also contemplated that combinations of structural support layers and backings, such as felt backings, may be utilized.

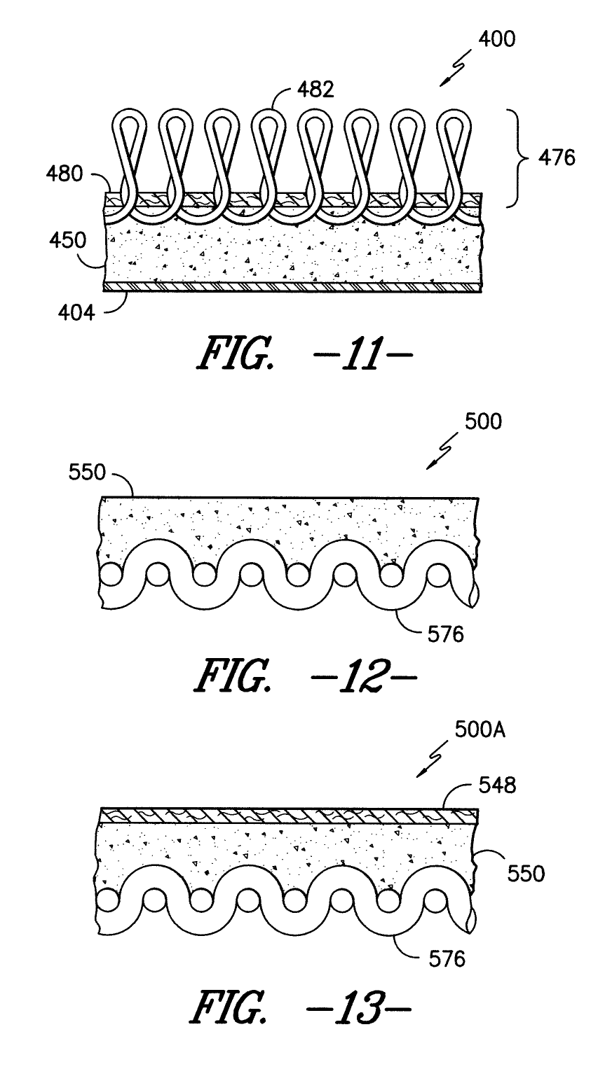

With reference to FIG. 11, a tufted face surface covering or product 400 like that of FIG. 7 is shown with an added backing or layer 404 such as a coating, film, or the like. For example, backing 404 may be an adhesive or other friction enhancing coating such as TractionBack coating offered by Milliken & Company of LaGrange, Ga. Backing 404 may also be the film or layer 47 of FIG. 1. Product 400 has a tufted textile face structure 476 incorporating an arrangement of yarn elements 482 tufted through a so called “primary backing” 480 such as a woven material, a scrim, a non-woven material, combined woven and non-woven material, or the like. As shown, the cured polyurethane composition 450 extends to the back stitch yarn bundles and the primary backing 480 thereby aiding in locking the yarn elements 482 in place. Although a level loop pile is shown, the pile may be level or textured (multilevel) loop, cut, cut and loop pile, or the like.

FIGS. 12-14 relate to an alternative production system and process wherein the face material 576 is inverted and then laid on the belt 512. Next, polyurethane composition 550 is poured, deposited, or applied to the back of the face material 576 and doctored by blade 558.

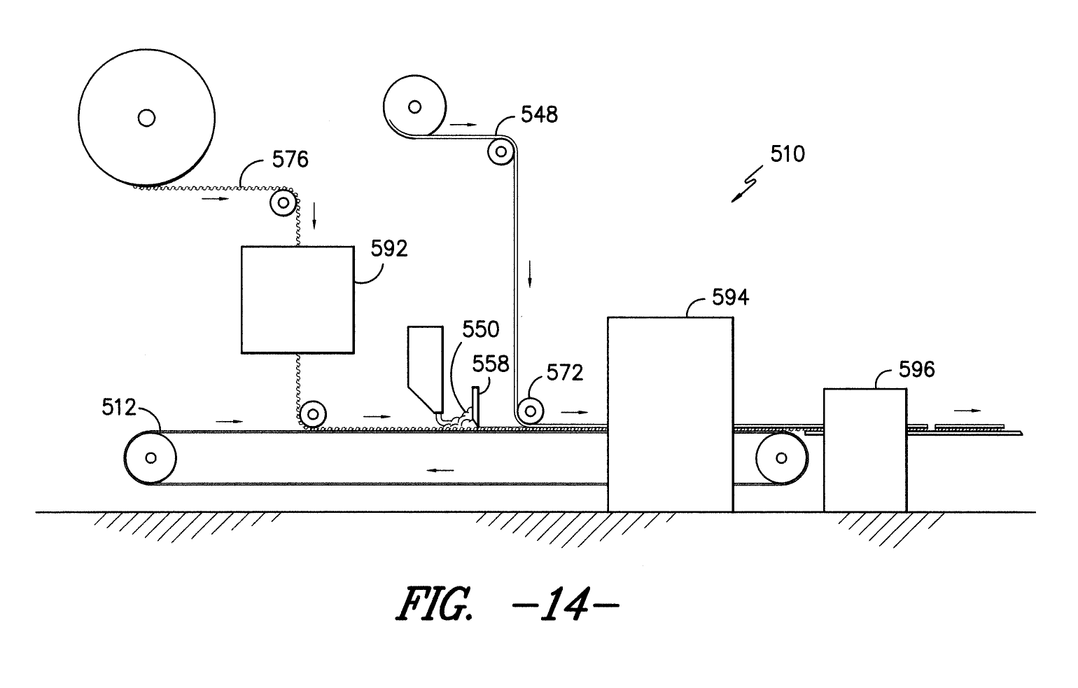

With respect to FIGS. 13 and 14, an optional backing 548 is added over the polyurethane 550 and nip or gauge roll 572 presses backing 548 into the polyurethane 550. Following introduction of the textile face structure 576 across the polyurethane composition 550, the resulting composite structure or assembly goes through roll or bar 572 or the like and thereafter may be moved through, for example, an elevated temperature curing range 594. The temperature in the curing range is preferably set to provide substantially complete curing of the polyurethane composition 550 or to provide at least sufficient curing to handle the composite 576, 550, 548. By way of example only and not limitation, such a curing range 594 having, for example, heated platens below belt 312, a platen temperature setting of about 250° F. in a first zone, and with a setting of about 290° F. in subsequent zones may provide good curing results when the belt 512 is operating at a rate of about 30 or 40 feet per minute. Of course, these setting may be readily adjusted as desired. For example, certain polyurethane backings may cure sufficiently to handle at room temperature (no heat required).

As shown, upon exiting the curing range 594, the composite or precursor with cured polyurethane (or partially cured polyurethane) may thereafter be removed from the belt 512 and sent to a cutter 596 for segmentation to a length and width as desired based on the final intended use or rolled to be cut or slit later or rolled as finished product. Cutter 596 may be a clicker for carpet tiles, a cut table for mats or rugs, a slitter, an ultrasonic, laser, air, or water cutter, or the like. Accordingly, the formation system 510 may be used to form carpet, carpet tile, area rugs, roll goods, and/or floor mats as may be desired. In this regard, it is to be understood that the composition, filler load, filler type, additives, agents, catalyst, density, and thickness of the polyurethane, the marriage point for the face and backing, the line speed, the procure, cure, and/or post cure temperatures, and/or the like may be adjusted depending upon the product being produced, the selected face, the selected backing, to optimize the process for the product, and/or the like.

One advantage of the system 510 of FIG. 14 is that the face material 576 tends to keep the belt 512 clean of polyurethane 550. Hence, a release film (such as film 47 of FIG. 1) may not be needed and alternative belt constructions may be used.

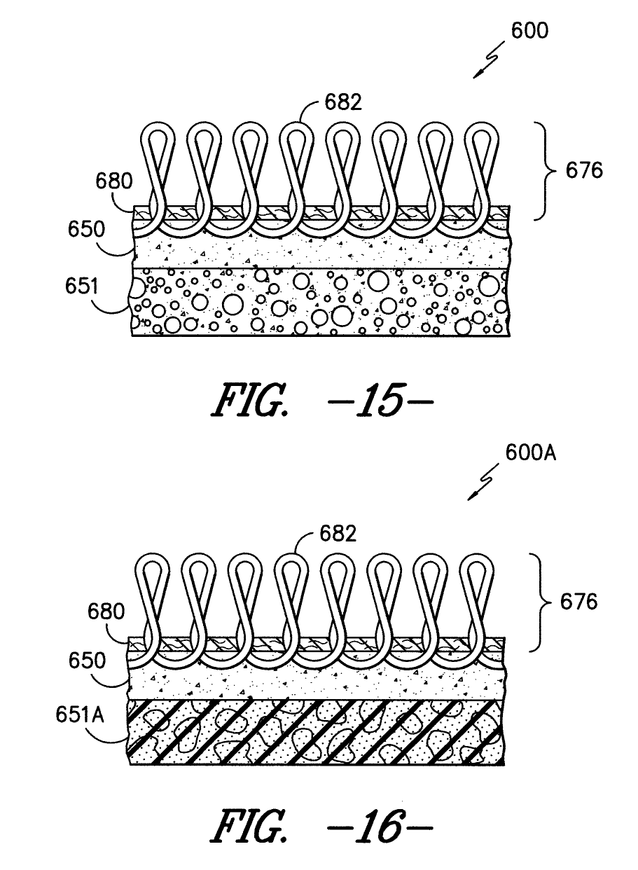

FIG. 15 illustrates a product or composite 600 having a tufted textile face structure 676 (greige goods face) incorporating an arrangement of yarn elements 682 tufted through a so called “primary backing” 680 such as a woven material, a scrim, a non-woven material, combined woven and non-woven material, or the like. As shown, the cured polyurethane composition 650 extends to the primary backing 680 and penetrates the yarn bundles thereby aiding in locking the yarn elements 682 in place and stabilizing primary 680. Although a level loop pile is shown, the pile may be level or textured (multilevel) loop, cut, cut and loop pile, or the like.

As shown in FIG. 15, an additional foam or foamed, blown, or cellular layer 651 is attached or bonded to the bottom of polyurethane layer 650. Preferably, foam layer 651 is added to provide a cushion layer to product 600 (cushion back) and is formed of polyurethane foam. Layer 651 may be a blown version of layer 650 or may be of a different make or composition than that of layer 650. For example, layer 651 may be a preformed polyurethane foam layer, an in situ formed polyurethane foam layer (like a foamed layer 62 of FIG. 1), an extruded layer, or the like. It may be preferred that both layers 650 and 651 each have a polyurethane composition including castor oil, monol, isocyanate, and optional catalyst, blowing agent, filler, and the like. For example, layers 650 and 651 may have similar compositions except that the layer 651 composition includes a blowing agent, more filler, and/or the like.

FIG. 16 illustrates a product or composite 600A having a tufted textile face structure 676 (greige goods face) incorporating an arrangement of yarn elements 682 tufted through a so called “primary backing” 680 such as a woven material, a scrim, a non-woven material, combined woven and non-woven material, or the like. As shown, the cured polyurethane composition 650 extends to and partially penetrates the primary backing 680 and may penetrate the yarn bundles thereby aiding in locking the yarn elements 682 in place and stabilizing primary 680. Although a level loop pile is shown, the pile may be level or textured (multilevel) loop, cut, cut and loop pile, or the like.

As shown in FIG. 16, an additional particle/binder layer 651A is attached or bonded to the bottom of polyurethane layer 650. Preferably, particle/binder layer 651A is a rebond foam type material added to provide a cushion layer to product 600A (cushion back) and is formed of, for example, recycled polyurethane foam chips and a polyurethane binder or adhesive. Layer 651A may be a large particle filled version of layer 650 or may be of a different make or composition than that of layer 650. For example, layer 651A may be a preformed polyurethane rebond foam layer, an in situ formed polyurethane rebond foam layer, an extruded layer, or the like. It may be preferred that both layers 650 and 651A each have a polyurethane composition including castor oil, monol, isocyanate, and optional catalyst, filler, and the like. For example, layers 650 and 651A may have similar polyurethane compositions except that the layer 651A has at least about 50% by volume (of the layer material) recycled foam chips, preferably at least about 60% by volume recycled foam chips, more preferably at least about 70% by volume recycled foam chips, still more preferably at least about 80% by volume recycled foam chips, and possibly most preferably at least about 85% by volume recycled foam chips, with the remainder of the volume being the polyurethane composition serving as binder (less than about 50% by volume binder, preferably less than about 40% by volume binder, more preferably less than about 30% by volume binder, still more preferably less than about 20% by volume binder, and possibly most preferably less than about 15% by volume binder), and other additives, agents, fillers, and/or the like.

The particles in particle/binder layer 651A may be, for example, pieces, particles, chips, and/or the like of one or more materials such as recycled, renewable, recyclable, bio-based, natural, and/or the like materials. Preferably, the particles are selected from recycled flooring, recycled backing, recycled face, recycled foam, recycled polyurethane foam, recycled rubber, recycled tire crumb, and/or the like. A low cost, recyclable product having recycled content of at least about 10% of the total weight of the product may be preferred. A low cost, recyclable product having recycled content of at least about 50% of the total weight of the product may be most preferred. Recycled content can be included in and/or added to one or more of the product components, elements, parts, structures, and/or the like, such as the face, precoat, tiecoat, backing, binder, filler, adhesive, and/or the like.

The underside or lower surface of the polyurethane layers 62, 84, 284, 350, 450, 550, 650, 651, and/or 651A may be textured, embossed, cleated, nubbed, ribbed, or the like to, for example, increase sliding friction with a floor or subfloor. Likewise, at least the lower surface of the lower most backing, film, coating and/or the like 47, 48, 404, and/or 548 may be embossed, textured, or the like.

The face material 76, 276, 376, 376A, 376B, 376C, 476, 576, and/or 676 may be formed of natural and/or synthetic fibers or materials, or blends thereof. For example, the face may be or may include polyamide such as Nylon 6 or Nylon 6,6, polyolefin, polyester, wool, bamboo, or blends thereof.

If face material 76, 276, 376, 376A, 376B, 376C, 476, 576, and/or 676 must be dyed or printed, it may be preferred that it be dyed prior to or following addition of the polyurethane layer or layers, addition of the backing, being cut into tiles, and/or the like. In one example, carpet tiles are formed and then tile dyed on a Millitron® jet dye machine by Milliken & Company of LaGrange, Ga.

In accordance with at least certain embodiments, the polyurethane compositions, formulations, and/or layers may include one or more castor oils, one or more other polyols, one or more isocyanates, one or more catalysts, and/or other agents, fillers, additives, and/or the like. If it is not desired or necessary to accelerate the cure, the catalyst may be eliminated.

In accordance with another example, one can blend recycled post-industrial waste filler (such as coal fly ash) with recycled post-consumer waste filler (such as crushed glass) to produce a hybrid recycled filler.

In accordance with still another example, one can mix recycled post-industrial filler and recycled post-consumer filler, with renewable or bio-based fillers or extenders such as cork, wood, corn, and/or the like.

The surface coverings or products of the present invention may be hardback or cushion back products. One can increase the cushion or resilience of the product by adding more face, more backing, air, a blowing agent, felt, and/or the like. It is possibly preferred that a polyurethane hardback or cushion back flooring product such as a polyurethane hardback or cushion back carpet tile have the structure of one of FIGS. 3, 4, 7 to 13, 15, 16, and/or variations thereof. It may also be preferred that a polyurethane backed area rug, roll goods, or floor mat of the present invention have the structure of one of FIGS. 7 to 13, 15, 16 and/or variations thereof.

In accordance with a particular example of a polyurethane backed floor covering in accordance with certain embodiments of the present invention, the floor covering has a structure like that of FIG. 7, having a tufted face greige carpet material (no precoat) with cut pile of Nylon 6,6 yarn that is jet dyed, dried, then laid over a mechanically frothed, MDI-based, uncured polyurethane backing composition that is poured onto a belt, doctored, and then joined to the carpet greige goods under a marriage roll. The polyurethane is then cured under heat.

In accordance with at least selected embodiments of the present invention, a nip, marriage, or gauge roll or bar 72, 372, 572, or the like presses the face material 76, 276, 376, 376A, 376B, 376C, 476, 576, and/or 676, backing 48 and/or 548, material 64, film 47, layer 651 and/or 651A, and/or the like into the uncured polyurethane composition and sets the height of the total product (prior to any chemical blowing).

The surface covering of the present invention may in at least one embodiment be 6 foot wide roll goods sometimes referred to as 6 foot broadloom or 6 foot goods, 2 meter wide roll goods sometimes referred to as 2 meter broadloom or 2 meter goods, or the like.

In accordance with at least selected embodiments, gravitational forces should dominate the sum of other process induced forces. Examples of these other forces are tensions or thermal contractions from cooling.

In accordance with at least selected embodiments, there is a desire to increase weight, reduce thickness, and/or reduce modulus of the composite, backing, product, or the like. The combination of a thin and heavy backing may require that the backing materials and/or fillers are characterized by higher density. This may be achieved by the selection of dense raw materials such as dense fillers. For example, CaCO₃ is a common filler used in floor covering products. It has a specific gravity (SG) of 2.6. If a filler is selected with a SG greater than 5 and the concentration by weight remained the same (>50%), then a significant shift in the compound or backing density would occur. If the choice were Iron (Fe) with a SG of 7.8 and with a concentration of about 70%, then the compound or backing density could be nearly tripled resulting in a heavier backing at the same add-on or in a ⅔ reduction in compound or backing thickness at the same compound or backing weight.

If a ferromagnetic material is selected as at least one filler, it creates the option of selectively creating magnetic properties in the backing. A magnetron located on or after the production range could be switched on/off to produce the optional magnetic property. If the ferromagnetic material is an oxide, such as ferrite, then the ferromagnetic material will not only be dense and magnetizable, but will also starve a fire event from oxygen and self extinguish. Hence, an oxide ferromagnetic material may be a preferred filler material, additive, or the like.

In accordance with at least selected embodiments, an exemplary surface covering such as a lay flat flooring product or tile has an upper show surface and a backing. It is preferred that the show surface such as a carpet or textile material be bonded to the backing during manufacture of the surface covering. The backing may preferably have a very low bending modulus (very flexible), a high density, is thin, and is resilient. Flexibility (low modulus) and high density (heavy) may be two factors that effect tile flatness.

The face or upper show surface is preferably an aesthetically pleasing carpet or textile material. For example, a graphics tufted, printed, dyed, or the like decorative carpet or textile (tufted, woven, bonded, nonwoven, flocked, needled, knit, or the like) of natural and/or synthetic fibers or blends, such as wool, bamboo, polyamide (Nylon), polyester, polyolefin, and the like, and/or blends or other combinations thereof.

Preferably, the face material exits the manufacturing process with substantially zero tension and resists growth or shrinkage during product use.

It is contemplated that the surface covering or flooring product may be any desired shape and may be in the form of roll goods, modular product, 6-foot broadloom, 12-foot broadloom, 2-meter broadloom, carpet, carpet tile, flooring, floor tile, floor covering, floor mat, stabilized broadloom, rug, runner, or the like. For example, a 6-foot wide or 2-meter wide roll of processed composite may be cut into tiles, rugs, mats, runners, and/or the like. The face 76, 376, 376A, 376B, 376C, 476, 576, 676, or the like is not limited to a precoated carpet or greige goods (non-precoated) face material although such a face may be preferred. Also, it may be possibly preferred that the face be range dyed (jet dyed) prior to lamination or backing to further reduce any latent stresses or tensions in the face. Further, lamination or backing of the face may be carried out at a low enough temperature and the face material or materials (for example, primary backing and tufts) may be selected to avoid the addition of stresses or instability (such as shrinkage) or bending moments (forces) such as tensions, contractions, or expansions (from thermal events) during processing, backing, lamination, curing, etc.

In accordance with alternative embodiments, the backing may include one or more stabilizing layers, backing layers, foam or cushion layers, a friction enhancing coatings, magnetic or magnetizable particles, remains flexible at standard operating temperatures, and/or the like.

In accordance with one example, the backing is a thin (less than about 5 mm, preferably less than about 3 mm), very flexible, dense, resilient, polymeric material.

In accordance with one example, the face is a jet dyed, tufted, polyamide (Nylon) 6 or 6,6 carpet face with a stable primary backing of, for example, woven and/or nonwoven polyamide (Nylon), polyester, polypropylene, and/or blends or other combinations thereof.

It may be preferred that the carpet face has a tuft lock or precoat of the same material as the backing, for example, a polyurethane precoat and a polyurethane backing.

In accordance with at least selected embodiments, a flexible floor tile, such as a flexible hardback carpet tile, a flexible cushion back carpet tile, or the like has a flexible backing and a tile drape of at least about 2 inches on a 6 inch tile overhang or cantilever, preferably of at least about 4 inches on a 6 inch tile overhang or cantilever, more preferably of at least about 5 inches on a 6 inch tile overhang or cantilever, and possibly most preferably of greater than 5 inches on a 6 inch tile overhang or cantilever. As used herein, the term “tile drape” is measured by placing a 9 inch square tile or 9 inch square tile piece (a piece or portion of a tile or tile precursor) (square shape with 9 inch sides or edges, with a tolerance of plus or minus 1/16 inch per side) (regardless of tile height and construction) face up on a flat, horizontal surface, with one 9 inch tile or tile piece edge parallel to a planar, vertical edge of the flat surface, moving the tile or tile piece transverse to and over the planar, vertical edge of the flat surface until 6 inches of the tile or tile piece overhangs the planar, vertical edge of the flat surface (6 inch tile overhang or cantilever). Then, while holding the remainder of the tile or tile piece flat down against the flat surface, measuring the difference in vertical height between the flat surface and the overhanging end (lowest point) of the tile or tile piece. The difference in height is the tile drape so long as the tile or tile piece is a 9 inch square (with a tolerance of plus or minus 1/16 inch per side). If the overhanging end of the tile or tile piece is not substantially level, then two measurements (most drape and least drape) are taken and averaged. If all four edges of a 9 inch square tile or tile piece do not have the same approximate drape, then the four drape measurements (one for each edge) are taken and averaged. If a tile is rectangular but not square, it is cut to be square (a 9 inch square) or a 9 inch square is cut out of it (preferably with two sides of the square parallel to the process direction) before measuring tile drape. Likewise, if the tile or tile piece is not rectangular or square, then it is cut to form a 9 inch square or a 9 inch square is cut out of it before measuring drape. If the tile or tile piece is less than 8 and 15/16 inches square but at least 1 and 15/16 inches by 8 and 15/16 inches, then one may measure product drape as described below.

In accordance with at least selected embodiments, a particular flexible hardback carpet tile has a flexible polyurethane backing made from a composition including castor oil, a monol, and an isocyanate and serving as at least one of a combined precoat and backing and a combined precoat and tiecoat, has a tufted greige goods face with at least about an 8 oz/yd² face weight, and has a tile drape of at least about 2 inches on a 6 inch tile overhang or cantilever, preferably of at least about 4 inches on a 6 inch tile overhang or cantilever, more preferably of at least about 5 inches on a 6 inch tile overhang or cantilever, and possibly most preferably of greater than 5 inches on a 6 inch tile overhang or cantilever.

In accordance with at least selected embodiments, a flexible flooring product, such as a flexible carpet, flexible broadloom carpet, flexible stabilized broadloom, flexible carpet tile, flexible modular carpet, flexible roll good, flexible six foot good, flexible two meter good, flexible rug, flexible area rug, flexible runner, flexible mat, flexible floor mat, or the like has a flexible backing and a product drape of at least about 2 inches on a 6 inch product overhang or cantilever, preferably of at least about 3 inches on a 6 inch product overhang or cantilever, more preferably of at least about 4 inches on a 6 inch product overhang or cantilever, and possibly most preferably of at least about 5 inches on a 6 inch product overhang or cantilever. As used herein, the term “product drape” is measured by placing a 2 inch by 9 inch rectangular shaped product or a 2 inch by 9 inch rectangular product piece (a piece or portion of a product or product precursor) (with a tolerance of plus or minus 1/16 inch per side or edge) (regardless of product height and construction) face up on a flat, horizontal surface, with one 2 inch product or product piece edge parallel to a planar, vertical edge of the flat surface, moving the product or product piece transverse to and over the planar, vertical edge of the flat surface until 6 inches of the product or product piece overhangs the planar, vertical edge of the flat surface (6 inch product overhang or cantilever). Then, while holding the remainder of the product or product piece flat down against the flat surface, measuring the difference in vertical height between the flat surface and the overhanging end (lowest point) of the 2 inch by 9 inch product or product piece. The difference in height is the product drape so long as the product or product piece is a rectangle having a width of 2 inches and a length of 9 inches (with a tolerance of plus or minus 1/16 inch per side). If the overhanging end of the product or product piece is not substantially level, then two measurements (most drape and least drape) are taken and averaged. If both of the 2 inch ends of the rectangular product or product piece do not have the same approximate drape, then the two drape measurements are taken and averaged. If a product or product piece is not a 2 inch by 9 inch rectangle, it is cut to be a rectangle having a width of 2 inches and a length of 9 inches or such a rectangle is cut out of it (preferably with the two long sides parallel to the process direction) (with a tolerance of plus or minus 1/16 inch per side) and the product drape can be measured on the 2 inch product or product piece edges at the opposite ends of the longest dimension (length) of the rectangular product or product piece. If the product or product piece is not at least 1 and 15/16 inches by 8 and 15/16 inches, one can measure drape but not “product drape”.

In accordance with at least selected embodiments, a particular flexible roll good has a flexible polyurethane backing made from a composition including castor oil, a monol, and an isocyanate and serving as at least one of a combined precoat and backing and a combined precoat and tiecoat, has a tufted greige goods face with at least about an 8 oz/yd² face weight, and has a product drape of at least about 2 inches on a 6 inch product overhang or cantilever, preferably of at least about 3 inches on a 6 inch product overhang or cantilever, more preferably of at least about 4 inches on a 6 inch product overhang or cantilever, and possibly most preferably of at least about 5 inches on a 6 inch product overhang or cantilever.

In accordance with at least certain embodiments, one principle of a lay flat tile design is that gravitational forces should dominate the sum of other process induced forces in the tile (such as tensions or thermal contractions from cooling).

Let us begin by studying the gravity model on a cantilever beam.

$${δ}_{B} = \frac{{qL}^{4}}{8 EI} \qquad Eqn . 1$$

This can be simplified for carpet tile applications by using:

$${δ}_{B} = \frac{{WL}^{4}}{864 {Et}^{3}} \qquad Eqn . 2$$

### Where:

W=the carpet weight (lbs/yd²)

L=Length of overhang (use 6″ as a constant)

E=Young's Modulus (σ/ε) for the composite

t=the bound thickness (in.)—do not include the pile height

δ=the maximum deflection of the beam (in.)

We can measure the weight (W), deflection (in.), and thickness (in.) in order to calculate the modulus (psi or pounds per square inch).

Assume W is held constant at 8 lbs/yd² (or 128 oz/yd²). Further assume t is held constant at 0.20 in. We can then see the relationship between δ and E.

If we now hold the Modulus constant (e.g., E=1,000 psi), we can then see the relationship between δ and t.

Finally, we can hold thickness and modulus constant and then see the relationship of δ and W.

Note that in each of these examples the equations assume that the angle of deflection is small such that the trigonometric approximation of sin (Y)=Y. In the present case, we want large deflections, so these become qualitative rather than quantitative figures.

Based on the above analysis, we see that in accordance with at least one aspect of the present invention, we may want to increase weight, reduce thickness, and reduce modulus (bending modulus) of the composite. Although heavier may be intuitive, the combination of thin and heavy is not, and requires that the tile backing materials are characterized by higher density. This may be achieved by the selection of dense raw materials such as dense fillers. For example, CaCO₃ is a common filler used in floor covering products. It has a specific gravity (SG) of 2.6. If a filler is selected with a SG greater than 5 and the concentration by weight remained the same (>50%), then a significant shift in the compound density would occur. If the choice was Iron (Fe) with a SG of 7.8 and with a concentration of 70%, then the density could be nearly tripled resulting in a ⅔ reduction in thickness at the same backing weight.

In at least one embodiment, an exemplary surface covering such as a lay flat flooring product or tile has an upper show surface and a backing. It is preferred that the show surface such as a carpet or textile material be bonded to the backing during manufacture of the surface covering. The backing preferably has a very low bending modulus (very flexible), a high density, is thin, and is resilient. Flexibility (low modulus, large drape) and high density (heavy) may be two most important factors that effect tile flatness. The face or upper show surface is preferably an aesthetically pleasing carpet or textile material. For example, a graphics tufted, printed, dyed, or the like decorative carpet or textile (tufted, woven, bonded, nonwoven, flocked, needled, knit, or the like) of natural and/or synthetic fibers such as wool, polyamide (Nylon), polyester, polyolefin, blends, and the like. Preferably, the face exits the manufacturing process with substantially zero tension and resists growth or shrinkage during product use. It is contemplated that the lay flat product may be any desired shape and may be in the form of roll goods, modular product, 6-foot broadloom, 12-foot broadloom, carpet, carpet tile, flooring, floor tile, floor covering, floor mat, stabilized broadloom, rug, runner, or the like. For example, a 6-foot wide or 2 meter wide roll of lay flat composite may be cut into tiles, rugs, mats, runners, and/or the like. The face is not limited to a precoated carpet or greige goods (non-precoated) face material although such a face may be preferred. Also, it may be possibly preferred that the face be range dyed (jet dyed) prior to lamination or backing to further reduce any latent stresses or tensions in the face. Further, lamination or backing of the face may be carried out at a low enough temperature and the face material or materials (for example, primary backing and tufts) may be selected to avoid the addition of stresses or instability (such as shrinkage) during processing, backing, lamination, curing, etc. In accordance with possibly preferred embodiments, the backing includes one or more stabilizing layers, backing layers, foam or cushion layers, a friction enhancing coating, magnetic or magnetizable particles, remains flexible at standard operating temperatures, and/or the like. In accordance with one example, the backing is a thin (less than about 5 mm, preferably less than about 3 mm), very flexible, dense, resilient, polymeric material.

In accordance with one example, the face is a jet dyed, tufted, polyamide (Nylon) 6 or 6,6 carpet face with a stable primary backing of, for example, woven and/or nonwoven polyamide (Nylon), polyester, and/or stabilized polypropylene. It may be preferred that the carpet face has a tuft lock or precoat of the same material as backing, for example, a polyurethane precoat and a polyurethane backing.

In accordance with another example, a hardback floor tile has a flexible, heavy (dense), thin backing with the following preferred properties:
1. Backing density—about 180 to 250 lbs/ft³ (3-4 g/cc)
2. Backing thickness—about 0.15 inch
3. Tile drape—about 2 to 6 inches of drape on a 6 inch tile overhang

In accordance with yet another example, a lay flat flooring product has a backing that is flexible, dense, thin, and/or resilient, as follows:
Flexible—product drape greater than about 2 inches of drape on a 6-inch product cantilever, tile drape greater than about 2 inches of drape on a 6-inch tile cantilever, and/or a bending modulus less than about 5000 psi, preferably less than about 4,000 psi, and more preferably less than about 3,000 psi;
Dense—backing density of greater than about 15 lbs/ft³;
Thin—backing height (thickness) of less than about 15 mm; and/or,
Resilient—product can be rolled around a cylinder, rod or dowel with an outer diameter of about 6 inches or less, preferably 4 inches or less, more preferably 2 inches or less, and will lay back flat, and/or can be folded in half (folded over on itself back to back with edges substantially aligned), preferably can be folded twice (folded over on itself back to back with edges substantially aligned, and then folded over again) and will go back to a lay flat position.

In accordance with still another example, a lay flat flooring product has a backing that is flexible, dense, thin, and/or resilient, as follows:
Flexible—product drape greater than about 3 inches of drape on a 6-inch product cantilever, tile drape greater than about 4 inches of drape on a 6-inch tile cantilever, and/or a bending modulus less than about 4,000 psi;
Dense—backing density of greater than about 20 lbs/ft³;
Thin—backing height (thickness) of less than about 7.5 mm; and/or,
Resilient—product can be rolled over a cylinder, dowel or rod having an outer diameter of less than about 3 inches and will go back to a lay flat position and/or folded over at least twice and will go back to a lay flat position.

In accordance with still yet another example, a lay flat flooring product has a backing that is flexible, dense, thin, and/or resilient, as follows:
Flexible—product drape greater than about 4 inches of drape on a 6-inch product cantilever, tile drape greater than about 5 inches of drape on a 6-inch tile cantilever, and/or a bending modulus less than about 3,000 psi;
Dense—backing density of greater than about 25 lbs/ft³;
Thin—backing height (thickness) of less than about 5 mm; and/or,
Resilient—product can be rolled over a cylinder, dowel or rod having an outer diameter of less than about 2 inches and will go back to a lay flat position and/or folded over at least twice and will go back to a lay flat position.

In accordance with another example, a lay flat flooring product has a backing that is flexible, dense, thin, and/or resilient, as follows:
Flexible—product drape greater than about 4 inches of drape on a 6-inch product cantilever, tile drape greater than about 5 inches of drape on a 6-inch tile cantilever, and/or a bending modulus less than about 2,000 psi;
Dense—backing density of greater than about 25 lbs/ft³;
Thin—backing height (thickness) of less than about 3 mm; and/or,
Resilient—product can be rolled over a cylinder, dowel or rod having an outer diameter of less than about 1 inch and will go back to a lay flat position and/or folded over at least twice and will go back to a lay flat position.

In accordance with a possibly preferred embodiment, a lay flat flooring product includes a face material and a backing bonded thereto during product manufacture.

In accordance with yet another embodiment, there is provided a method of producing a lay flat flooring product such as a lay flat tile or roll goods product with a carpet or textile face and a flexible, heavy, thin, resilient backing, comprising the steps of: preparing a backing composition; depositing the backing composition in a layer; placing a carpet or textile face material on the deposited backing layer to form a multi-layer structure; setting or curing the backing so that the backing composition forms a flexible, heavy, thin, resilient backing, and wherein the carpet or textile face material is bonded to the backing.

In accordance with at least selected examples, the preferred backing may be filled polyurethane (greater than 50% by weight filled). Although less preferred, other materials which will provide a relatively heavy, thin, flexible, and resilient backing may be used. For example, rubber, latex, extruded polymers, hot melts, adhesives, films, acrylics, and the like may be used.

In accordance with at least selected examples, the preferred precoat or adhesive may be an unfilled or lightly filled polyurethane (less than 20% by weight filled). Although polyurethane adhesive is preferred, other known adhesives may be used. For example, hot melts, polymers, polyolefins, extruded polymers, acrylics, or the like.

In accordance with at least one example, a method of producing a lay flat product includes the steps of:

1. Producing a substantially tensionless face;

2. Treating the face to remove stresses;

3. Laminating or backing the face;

4. Selectively magnetizing the composite; and,

5. Rolling or cutting the composite to form lay flat products.

In accordance with at least one embodiment, there is provided a method of forming combinations of floor covering products selected from carpet, carpet tiles, area rugs, floor tiles, runners, mats, and floor mats on a single processing line, the method comprising the steps of:
(a) delivering a mass of polyurethane forming composition onto an endless belt;
(b) leveling the polyurethane forming composition to a desired thickness;
(c) placing a preformed textile face structure into overlying contacting relation with the leveled polyurethane forming composition to form an assembly;
(d) at least partially curing the polyurethane forming composition of the assembly in place across the underside of the textile face structure to form a composite; and,
(e) cutting the composite of textile face structure with at least partially cured polyurethane to at least two different sizes, to form at least two different products, or both.

In accordance with at least selected embodiments, there is provided a surface covering such as a carpet, carpet tile, area rug, floor mat or the like incorporating a textile face disposed in contacting overlying relation to at least a polyurethane layer. One or more optional intermediate structure layers may be disposed within the polyurethane and one or more optional backing layers may be disposed across the underside of the polyurethane.

At least one embodiment may provide advantages over and/or alternatives to the prior constructions by providing a surface covering such as a carpet, carpet tile, area rug, floor mat, flooring, floor tile, rug, mat, broadloom carpet, stabilized broadloom, roll goods, modular flooring, 6-foot broadloom, 2-meter broadloom, or the like incorporating a textile face, such as a tufted, bonded, flocked, needled, needle punched, woven, non-woven, or knit fabric structure disposed in contacting overlying relation to at least one polyurethane layer. One or more optional intermediate structure layers may be disposed over, in or under the polyurethane and one or more optional backing layers may be disposed across the underside of the polyurethane.

At least selected embodiments may provide advantages over and/or alternatives to the prior constructions by providing processes, methods, uses, apparatus, and/or products, for example, surface coverings such as floor coverings having a show surface such as a textile or fabric face material in contacting overlying relation to a polymer or resin backing, such as a polyurethane backing with or without additional structures, layers, backings, and/or the like, as well as apparatus, processes, and/or methods for making such surface coverings, uses for such surface coverings, and/or the like. In at least one particular embodiment, a floor covering such as a carpet, carpet tile, area rug, floor mat, roll goods, or the like incorporates a textile or fabric face, such as a tufted, bonded, flocked, needled, needle punched, woven, non-woven, or knit textile or fabric structure disposed in contacting overlying relation to at least one polyurethane layer. The polyurethane layer may form a precoat, tiecoat, backing, secondary backing, cap coat, binder, cushion and/or adhesive and may be foam or non-foam, and may preferably be resilient and/or flexible. One or more optional intermediate structure layers may be disposed over, in or under the polyurethane and one or more optional backing layers may be disposed across the underside of the polyurethane. In at least one more particular embodiment or example, a floor covering such as a hardback carpet, carpet tile, area rug, roll goods, or the like incorporates a textile or fabric face, such as a tufted, bonded, flocked, needled, needle punched, calendered, woven, non-woven, or knit textile or fabric structure (for example, tufted greige goods) disposed in overlying, contacting, bonding relation to a flexible and/or resilient, hardback polyurethane backing. With a tufted greige goods face material (unbacked carpet face), the polyurethane backing may form a combined precoat and backing. Although it may not be preferred, one or more optional intermediate structure layers may be disposed over, in or under the polyurethane backing and one or more optional backing layers may be disposed across the underside of the polyurethane backing.

In accordance with at least selected embodiments, processes, methods, uses, apparatus, and/or products are provided, for example, surface coverings such as floor coverings, for example, carpet, carpet tiles, area rugs, floor mats, flooring, floor tiles, rugs, mats, broadloom carpet, stabilized broadloom, roll goods, modular flooring, 6-foot broadloom, 2-meter broadloom, or the like incorporating a textile or fabric face, such as a tufted, bonded, flocked, needled, needle punched, woven, non-woven, or knit textile or fabric structure disposed in contacting overlying relation to at least one polymer or resin layer, such as a polyurethane layer or backing. One or more optional intermediate structure layers may be disposed over, in or under the polyurethane and one or more optional backing layers may be disposed across the underside of the polyurethane.

According to a potentially preferred particular embodiment or example, the polyurethane is in direct contacting relation with the underside of the textile face structure without the need for any intermediate binder or precoat.

According to another potentially preferred particular embodiment or example, the textile face structure is preferably substantially relaxed such as by steaming, dyeing or the like prior to application of the polyurethane to substantially avoid subsequent deformation, for example, due to shrinkage.

According to still another potentially preferred particular embodiment or example, a common formation unit and process may be used to produce carpet, area rugs, carpet tile, floor mats, and the like.

According to yet another potentially preferred particular embodiment or example, resilient and/or flexible, polyurethane hardback carpet tiles having, for example, a tufted or bonded carpet surface are provided. Such carpet tiles may preferably be employed in residential, educational, institutional, health care, hospitality, and/or commercial installations or markets.

According to other potentially preferred particular embodiments or examples, resilient and/or flexible, polyurethane hardback carpet tiles have a tile drape or product drape of at least about 2 inches, are commercially viable products (pass, meet or exceed standard commercial hardback carpet tile tests, specs, or performance requirements), can be rolled on a cylinder, dowel or rod having a outer diameter of less than about 4 inches and will go back flat, can be folded at least once (folded in half back to back so it ends up halved) and goes back flat, have bio-based content backing material, have recycled content in the backing, are relatively low cost, are dyeable, are printable, have a moisture barrier, are less than ½ inch thick, have no added stabilizing layer, have a greige goods face, have a single layer combined precoat and backing, have a high filler content backing, have a backing weight of less than about 100 oz/yd², have a face weight of greater than about 5 oz/yd² but less than 65 oz/yd², have a tufted or bonded carpet face, have a backing bending modulus of less than about 5,000 psi, have a thin backing, have a flexible backing, have a dense backing, have a low modulus backing, and/or the like.

According to yet other potentially preferred particular embodiments or examples, resilient and/or flexible, polyurethane hardback carpet tiles have a tile drape or product drape of at least about 3 inches, are commercially viable products (pass, meet or exceed standard commercial hardback carpet tile tests, specs, or performance requirements), can be rolled on a cylinder, dowel or rod having a outer diameter of less than about 3 inches and will go back flat, can be folded at least twice (folded in half back to back, and then folded in half again face to face so it ends up quartered) and goes back flat, have bio-based content backing material, have recycled content in the backing, are relatively low cost, are jet dyeable, are printable, have a moisture barrier, are less than ⅜ inch thick, have no added stabilizing layer, have a greige goods face, have a single layer combined precoat and backing, have a high filler content backing, have a backing weight of less than about 80 oz/yd², have a face weight of greater than about 8 oz/yd² but less than 65 oz/yd², have a tufted or bonded carpet face, have a backing bending modulus of less than about 4,000 psi, have a thin backing, have a flexible backing, have a dense backing, have a low modulus backing, and/or the like.

According to other potentially preferred particular embodiments or examples, resilient and/or flexible, polyurethane hardback carpet tiles have a tile drape or product drape of at least about 4 inches, are commercially viable products (pass, meet or exceed standard commercial hardback carpet tile tests, specs, or performance requirements), can be rolled on a cylinder, dowel or rod having a outer diameter of less than about 2 inches and will go back flat, can be folded at least twice (folded in half back to back, and then folded in half again face to face so it ends up quartered) and goes back flat, have bio-based content backing material, have recycled content in the backing, are relatively low cost, are jet dyeable, are printable, have a moisture barrier, are less than ¼ inch thick, have no added stabilizing layer, have a greige goods face, have a single layer combined precoat and backing, have a high filler content backing, have a backing weight of less than about 70 oz/yd², have a face weight of greater than about 8 oz/yd² but less than 65 oz/yd², have a tufted or bonded carpet face, have a backing bending modulus of less than about 3,000 psi, have a thin backing, have a flexible backing, have a dense backing, have a low modulus backing, and/or the like.

While the present invention has been illustrated and described in relation to certain potentially preferred embodiments and practices, it is to be understood that the illustrated and described embodiments and practices are illustrative only and that the present invention includes such embodiments but is not limited thereto. Rather, it is fully contemplated that modifications and variations to the present invention will no doubt occur to those of skill in the art upon reading the above description and/or through practice of the invention. It is therefore intended that the present invention shall extend to all such modifications and variations as may incorporate the broad principles of the present invention within the full scope thereof as set forth in the appended claims.

What is claimed is:

1. A composition comprising:
the reaction product of a reactant composition comprising:
(a) castor oil;
(b) a monol with a functionality of about 1, and
(c) an isocyanate,
wherein the reactant composition has a soft segment functionality of about 2.0 to about 2.64.

2. The composition of claim 1, wherein the reactant composition has a soft segment functionality of about 2.07 to about 2.64.

3. The composition of claim 1, wherein the reactant composition has a soft segment functionality of about 2.1 to about 2.4.

4. The composition of claim 1, wherein the reactant composition has a system functionality of about 2.0 to about 2.64.

5. The composition of claim 1, wherein the reactant composition has a system functionality of about 2.0 to about 2.4.

6. The composition of claim 1, wherein the reactant composition has a system functionality of about 2.07 to about 2.38.

7. The composition of claim 1, wherein the reactant composition has a system functionality of about 2.1 to about 2.25.

8. The composition of claim 1, wherein said composition has a Shore A hardness of greater than or equal to about 50.

9. The composition of claim 1, wherein said composition has a specific gravity of about 1.2 to about 5.

10. The composition of claim 1, wherein said composition has a film drape of greater than or equal to about 2 inches.

11. The composition of claim 1, wherein said composition has a film drape of about 2 to about 3.125 inches.

12. The composition of claim 1, wherein said composition has a tensile strength of greater than or equal to about 100 psi.

13. The composition of claim 1, wherein said castor oil has a water content of less than or equal to about 0.2% by weight

14. The composition of claim 1, wherein said castor oil has a water content of less than or equal to about 0.1% by weight

15. The composition of claim 1, wherein said composition has:
a system functionality of about 2.0 to about 2.64
a tensile strength of greater than or equal to about 100 psi;
a film drape of greater than or equal to 2 inches; and
a Shore A hardness of greater than or equal to 50.

16. The composition of claim 1, wherein said monol is a glycol ether, a C₄ to C₁₈ alcohol or an ester alcohol.

17. The composition of claim 1, wherein said monol is monobutyl glycol ether.

18. The composition of claim 1, wherein said composition further comprises a filler.

19. The composition of claim 18, wherein said filler is calcium carbonate, sand, used foundry sand, recycled gypsum, recycled glass, glass particles, glass fibers, cork, coal fly ash, recycled metal, rubber, recycled rubber, alumina trihydrate or combinations thereof.

20. The composition of claim 18, wherein said composition further comprises a viscosity modifier.

21. The composition of claim 20, wherein said viscosity modifier is fumed silica.

22. The composition of claim 1, wherein said composition is thixotropic.

23. A composition comprising:
the reaction product of the reactants:
(a) about 15 to about 98 parts by weight castor oil;
(b) about 1 to about 30 parts by weight of a monol; and
(c) about 5 to about 60 parts by weight of an isocyanate;
0 to about 500 dry parts by weight coal fly ash; and
to about 5 dry parts by weight fumed silica.
